(19) United States
(12) Patent Application Publication
(10) Pub. No.: US 2005/0058577 A1
(43) Pub. Date: Mar. 17, 2005

(54) Material removal and dispensing devices, systems, and methods

(75) Inventors: Kenneth J. Micklash II, Royal Oak, MI (US); Robert Charles Downs, La Jolla, CA (US); Jim Yuchen Chang, San Diego, CA (US); James Kevin Mainquist, San Diego, CA (US)

Correspondence Address: QUINE INTELLECTUAL PROPERTY LAW GROUP, P.C., P O BOX 458, ALAMEDA, CA, 94501, US

(73) Assignee: IRM, LLC, Hamilton (BM)

(21) Appl. No.: 10/821,127

(22) Filed: Apr. 7, 2004

Related U.S. Application Data
(60) Provisional application No. 60/461,638, filed on Apr. 8, 2003.

(51) Int. Cl. B01L 3/00

(52) U.S. Cl. 422/99; 422/102

(57) ABSTRACT

The present invention provides material removal heads and devices for noninvasively removing materials from the wells of multi-well plates. The material removal heads of the invention are structured to prevent cross-contamination among wells of multi-well plates as materials are removed from the plates. The invention also provides dispense heads and devices that include angled dispensers. Related systems, kits, and methods are additionally provided.

### CROSS-REFERENCES TO RELATED APPLICATIONS

This application claims the benefit of U.S. Provisional Application No. 60/461,638, filed Apr. 8, 2003, the disclosure of which is incorporated by reference in its entirety for all purposes.

### COPYRIGHT NOTIFICATION

Pursuant to 37 C.F.R. § 1.71(e), Applicants note that a portion of this disclosure contains material which is subject to copyright protection. The copyright owner has no objection to the facsimile reproduction by anyone of the patent document or patent disclosure, as it appears in the Patent and Trademark Office patent file or records, but otherwise reserves all copyright rights whatsoever.

### BACKGROUND OF THE INVENTION

The multi-well plate has rapidly become a standard format utilized in many modern pharmaceutical discovery and development procedures, including various biochemical and cell-based assays. For example, numerous common cell-based assay steps are routinely performed in parallel in multi-well plates. These include steps such as dispensing and removing cell culture media, washing cells, dosing cells with drug candidates, incubating cell cultures, and detecting cellular responses. The advantages of these methods of screening candidates include significantly enhanced throughput relative to previous approaches. Throughput is improving even further as many of these assays are being performed in increasingly automated systems.

More specific examples of common types of assays performed in multi-well plates include those relating to signal transduction, cell adhesion, apoptosis, cell migration, GPCR, cell permeability, receptor/ligand assays, and cell growth/proliferation. Additional details relating to these and other assays involving multi-well plates are described in, e.g., Parker et al. (2000) “Development of high throughput screening assays using fluorescence polarization: nuclear receptor-ligand binding and kinase/phosphatase assays,” J. Biomolecular Screening 5(2):77-88, Asa (2001) “Automating cell permeability assays,” Screening 1:36-37, Norrington (1999) “Automation of the drug discovery process,” Innovations in Pharmaceutical Technology 1(2):34-39, Fukushima et al. (2001) “Induction of reduced endothelial permeability to horseradish peroxidase by factor(s) of human astrocytes and bladder carcinoma cells: detection in multi-well plate culture,” Methods Cell Sci. 23(4):211-9, Neumayer (1998) “Fluorescence ELISA, a comparison between two fluorogenic and one chromogenic enzyme substrate,” BPI 10(Nr. 5), Graeff et al. (2002) “A novel cycling assay for nicotinic acid-adenine dinucleotide phosphate with nanomolar sensitivity,” Biochem J. 367(Pt 1):163-8, Rogers et al. (2002) “Fluorescence detection of plant extracts that affect neuronal voltage-gated Ca²⁺ channels,” Eur. J. Pharm. Sci. 15(4):321-30, and Rappaport et al. (2002) “New perfluorocarbon system for multilayer growth of anchorage-dependent mammalian cells,” Biotechniques 32(1):142-51.

Many of the protocols referred to above include steps in which materials are dispensed into and/or removed from wells disposed in the multi-well plates. To illustrate, certain cell-based ELISA assays involve removing solvents or other fluidic materials from wells in which cells remain adhered to well sides or bottoms. Thereafter, new fluids may be dispensed into the wells, e.g., to wash the cells or the like. Pre-existing devices used to remove these fluidic materials from the wells typically utilize syringe or vacuum pumps having tips that invasively aspirate the fluids from the wells. These invasive techniques, which typically involve inserting the tips into the wells to contact and penetrate fluid surfaces to effect aspiration, oftentimes necessitate washing the device tips between successive aspirations in an effort to minimize cross-contamination among wells in the multi-well plate. The invasiveness and frequent tip washings associated with these approaches significantly limit assay throughput. In addition, the openings to these tips generally have small internal dimensions (e.g., diameters) that are easily plugged or otherwise obstructed by cells or other debris aspirated from the wells. In many instances, this leads to incompletely emptied wells, which can ultimately yield biased assay results. Plugged tips in these pre-existing devices, which can be difficult to detect, must generally be unplugged or replaced. This “down time” further limits assay throughput.

From the foregoing, it is apparent that additional devices, systems, and methods for removing materials from multi-well plates or other multi-well containers are desirable. More specifically, it is desirable to noninvasively remove materials from multi-well containers, inter alia, to minimize both cross-contamination among wells of these containers and the number of device washing steps performed between material removal steps. These attributes significantly improve the throughput, flexibility, and quality of assays or other procedures that involve the multi-well format relative to those performed with pre-existing devices and methods. These and a variety of additional features of the present invention will become evident upon complete review of the following disclosure.

### SUMMARY OF THE INVENTION

The present invention generally relates to the removal of material from wells disposed in multi-well plates (e.g., micro-well plates, reaction blocks, or the like). In particular, the invention provides material removal heads that noninvasively remove materials, such as solid and/or fluidic materials, from multi-well plates. In addition to noninvasive material removal, the material removal heads of the invention typically comprise portions (e.g., tips, surfaces, etc.) that are structured to minimize cross-contamination among wells when materials are removed from the plates. The material removal heads are generally also included as components of devices or systems of the invention. The devices and systems described herein may be utilized to perform, e.g., well washing or cleaning steps, various assays, and other procedures with throughput that is superior to those processes performed using pre-existing devices. The invention also provides methods of noninvasively removing materials from multi-well plates and kits that include the material removal heads described herein.

In one aspect, the invention relates to a material removal head for removing materials from one or more wells of a multi-well plate. The material removal head includes at least one tip that a) comprises at least one vent opening, at least one inlet and at least one outlet, which inlet communicates with the outlet (e.g., includes a channel or other cavity disposed through the tip), and b) is structured such that when the inlet is disposed proximal to a selected well from which a material is to be removed, the tip forms a barrier between the selected well and at least one adjacent well. Further, when the outlet is operably connected to a negative pressure source, air is drawn through the vent opening and into the inlet, thereby noninvasively removing a material from the selected well while the barrier prevents cross-contamination of the adjacent well. In some embodiments, the tip is coupled to a body structure of the material removal head by a resilient coupling, e.g., to account for surface variations of multi-well plates, to prevent damage to the tips and to multi-well plates, etc. when materials are noninvasively removed from the plates. In some embodiments, material removal heads of the invention include one or more manifolds such that, for example, multiple inlets can communicate with one or more outlets, or multiple outlets can communicate with one or more inlets.

The tips utilized in the material removal heads of the invention include various embodiments. For example, a tip is optionally structured such that when the inlet is disposed proximal to the selected well, the tip forms a barrier between the selected well and one or more, and in some embodiments three or more, adjacent wells. In some embodiments, the tip includes angled surfaces that mate with sides of the selected well. One of the angled surfaces typically includes a vent opening that allows air passage into the selected well, to allow the applied vacuum to produce a flow of air that effects non-invasive removal of material from the well.

In certain embodiments, the tip includes a seal material disposed around the tip (e.g., a coating or the like). The seal material typically includes rubber or another compliant material. When the tip is disposed proximal to the selected well, the seal material substantially seals one or more adjacent wells, thereby preventing cross-contamination of the adjacent wells when materials are removed from the selected well. In these embodiments, a vent opening can be formed between the seal material and one side of the tip, which vent opening allows air passage into the selected well.

In some embodiments, the material removal heads of the invention include multiple tips. To illustrate, a material removal head typically includes at least two tips in which the inlets of the tips are spaced at a distance that substantially corresponds to a distance between at least two wells disposed in a multi-well plate. For example, a material removal head optionally includes a plurality of tips at least a subset of which comprises a footprint that substantially corresponds to a footprint of at least a subset of at least one line of wells disposed in a multi-well plate. In these embodiments, for example, the number of spacing regions disposed between adjacent tips in a line of tips is typically a multiple of the number of spacing regions disposed between adjacent wells in a corresponding line of wells disposed in the multi-well plate. To further illustrate, the material removal heads of the invention optionally include a plurality of tips in which centers of at least two of the inlets of the tips are spaced 18 mm, 9 mm, 4.5 mm, 2.25 mm, or less apart from one another. A material removal head simultaneously removing materials from all wells of one line of a 96-well plate can include, for example, 8 tips or 12 tips. A material removal head for a 384-well plate can include, for example, 16 tips or 24 tips. For a 1536-well plate, a material removal head can have 32 or 48 tips. Alternatively, the material removal head can be structured to simultaneously remove materials from a subset of wells in a line of wells. For example, a material removal head that includes 16 or 24 tips can be used to simultaneously remove materials from half of the wells in a row or column of wells.

In another aspect, the invention provides a material removal head that includes at least one vent opening, at least one inlet and at least one outlet, which inlet communicates (e.g., fluidly, etc.) with the outlet. The inlet is structured to noninvasively remove material from at least one selected well disposed in at least one multi-well plate when the outlet is operably connected to at least one negative pressure source, thereby drawing air through the vent opening and into the inlet. A surface of the material removal head that includes the inlet is structured to substantially seal at least one non-selected well in the multi-well plate when the inlet is disposed proximal to the selected well from which the material is to be removed. In some of these embodiments of the invention, such as those included in the devices and systems described herein, the surface of the material removal head that includes the inlet is generally substantially flat, e.g., to effect the sealing of non-selected wells disposed proximal to those from which materials are removed to minimize cross-contamination among the wells.

In an additional aspect, the present invention provides a material removal head that includes at least one tip that extends from the material removal head. The tip includes at least one inlet. In preferred embodiments, the material removal head includes multiple tips, each having at least one inlet. The material removal head further includes at least one outlet that communicates with the inlet, which inlet is structured to noninvasively remove material from at least one well disposed in at least one multi-well plate when the outlet is operably connected to at least one negative pressure source. Further, the tip is structured to mate with the well from which the material is to be removed to form a barrier between the well and one or more adjacent material-containing wells when the material is removed.

In another aspect, the present invention relates to a material removal head that includes at least one vent opening, at least one inlet and at least one outlet, which inlet communicates with the outlet, in which the inlet includes a first cross-sectional dimension that is less than or equal to a first cross-sectional dimension of at least one well disposed in at least one multi-well plate. The material removal head has a cross-sectional dimension that substantially corresponds to at least a segment of a length of at least one line of wells disposed in the multi-well plate. The material removal head is structured to noninvasively remove material from one or more wells disposed in the line of wells when inlet is disposed proximal to the wells and the outlet is operably connected to at least one negative pressure source, thereby drawing air through the vent opening and into the inlet. Furthermore, a surface of the material removal head that includes the inlet is structured to substantially seal at least one other well in the multi-well plate when the inlet is disposed proximal to the well from which the material is to be removed.

In certain embodiments of the invention, the negative pressure source (e.g., a pump, etc.) is operably connected to the outlet. In these embodiments, the material removal head and negative pressure source together comprise a material removal device. In some embodiments, the material removal device is hand-held, whereas in others, material removal heads or devices are components of systems. Typically, at least one tube operably connects the negative pressure source to the outlet. Optionally, the negative pressure source is integral with the material removal head. In preferred embodiments, the negative pressure sources described herein apply pressures of at least 28.5 inches Hg at material removal head inlets at flow rates of at least 0.3 cubic feet per minute. In addition, at least one valve (e.g., a solenoid valve, etc.) is typically operably connected to the material removal device, which valve regulates pressure flow from the negative pressure source. Optionally, at least one trap is operably connected to the material removal device, which trap is structured to trap waste material.

In another aspect, the invention relates to a dispense head that includes at least one dispenser that is structured to dispense material (e.g., fluidic materials, etc.) into one or more wells of at least one multi-well plate. The dispenser is angled (e.g., between about 0° and about 90°) relative to a Z-axis so that the material is dispensed onto the sides of the wells when the dispenser is operably connected to a material source and the material is dispensed from the dispenser. When fluidic materials are dispensed, for example, angled dispensers direct the flow of these materials into contact with the sides of the selected wells before the materials contact other parts of the wells. Among other advantages, this minimizes the formation of bubbles in the wells, which might otherwise bias assay results, e.g., upon detection.

In still another aspect, the invention provides a multi-well plate processing system. The system includes at least one material removal head as described herein. The system can also include at least one negative pressure source (e.g., a pump, etc.). For example, the material removal head typically includes at least one vent opening, at least one inlet and at least one outlet, which inlet communicates with the outlet and which outlet is operably connected to the negative pressure source (e.g., via at least one tube or other conduit). The inlet is structured to noninvasively remove material from at least one selected well of at least one multi-well plate when the selected well is disposed proximal to the inlet and the negative pressure source applies a negative pressure to the outlet, thereby drawing air through the vent opening and into the inlet. The material removal head is structured to noninvasively remove fluidic material from the multi-well plate. The multi-well plate processing system also typically includes at least one valve (e.g., a solenoid valve, etc.) operably connected to the material removal component, which valve is structured to regulate pressure flow from the negative pressure source. In addition, the system optionally includes at least one trap that is operably connected to the material removal component, which trap is structured to trap waste material, e.g., for subsequent disposal.

In certain embodiments of the invention, for example, a surface of the material removal head that includes the inlet is substantially flat. In other embodiments, the material removal head includes at least one tip that comprises the vent opening, the inlet and the outlet, which tip is structured such that when the inlet is disposed proximal to the selected well from which a material is to be removed, the tip forms a barrier between the selected well and at least one adjacent well. In these embodiments, the tip is typically resiliently coupled to the material removal head by at least one resilient coupling. The tip is generally structured to mate with selected wells from which the material is to be removed. In preferred embodiments, the material removal head includes multiple tips.

The multi-well plate processing system further includes at least one positioning component that is structured to position one or more multi-well plates relative to the material removal head, or at least one dispensing component that is structured to dispense one or more materials (e.g., cleaning solutions, solvents, reagents, etc.) into one or more wells of one or more multi-well plates. In certain embodiments, the system includes both the positioning component and the dispensing component. Typically, the dispensing component includes at least one dispenser that aligns with one or more wells disposed in one or more multi-well plates when the multi-well plates are disposed proximal to the dispenser. In some embodiments, the dispensing component is structured to dispense one or more fluidic materials. In some embodiments, the dispensing component is structured to dispense the materials to a plurality of multi-well plates substantially simultaneously. In certain embodiments, the dispensing component includes at least one dispenser that is angled (e.g., between about 0° and about 90°) relative to a Z-axis so that materials are dispensed onto the sides of selected wells (i.e., the materials contact the sides of the wells before other parts of the wells), e.g., to minimize bubble formation when fluidic materials are dispensed, to minimize the disruption of other materials disposed in the wells when materials are dispensed into the wells, and/or the like.

The dispensing components of the multi-well plate processing systems can, in some embodiments dispense the materials through the outlet and inlet of the material removal heads. For example, each outlet can be operably connected to a valve that switches between a conduit that leads to a reservoir that contains a material to be dispensed into a well and a conduit that is connected to the negative pressure source and leads to a waste container for materials that are removed from a well.

The multi-well plate processing system of the invention optionally includes one or more additional components. For example, the system optionally includes at least one robotic gripping component that is structured to grip and translocate multi-well plates between components of the multi-well plate processing system and/or between the multi-well plate processing system and another location. In certain embodiments, the system also includes at least one multi-well plate storage component (e.g., a hotel, a carousel, etc.) that is structured to store one or more multi-well plates. In some embodiments, the system also includes at least one incubation component that is structured to incubate one or more multi-well plates. The system also optionally includes at least one translocation component that is structured to translocate one or more of the material removal component, the positioning component, or the dispensing component relative to one another (e.g., along an X-, Y-, and/or Z-axis). In some embodiments, the system further includes at least one washing component that is structured to wash at least a portion of the material removal component and/or the dispensing component. In certain embodiments, the system also includes at least one detection component that is structured to detect detectable signals produced in one or more wells disposed in one or more multi-well plates. Optionally, the system also includes a multi-well plate-moving component that is structured to move one or more multi-well plates at least relative to the material removal component. In addition, the multi-well plate processing system also typically includes at least one controller that is operably connected to one or more components of the multi-well plate processing system, which controller controls operation of the components. The controller generally includes or is operably linked to at least one computer.

In preferred embodiments, a material removal head as described herein includes multiple inlets, such that materials can be removed from multiple wells substantially simultaneously. In some embodiments, for example, the material removal heads of the invention include at least two inlets that are spaced at a distance that substantially corresponds to a distance between at least two wells disposed in a multi-well plate. For example, material removal heads typically include a plurality of inlets in which centers of at least two of the inlets are spaced 18 mm, 9 mm, 4.5 mm, 2.25 mm, or less apart from one another so that they correspond to the center-to-center spacing between adjacent wells in, e.g., 24-, 96-, 384-, or 1536-well micro-well plates, respectively. To further illustrate, material removal heads optionally include a plurality of inlets at least a subset of which have a footprint that substantially corresponds to a footprint of at least a subset of at least one line of wells disposed in a multi-well plate. In these embodiments, the number of spacing regions disposed between adjacent inlets in a line of inlets is typically a multiple of the number of spacing regions disposed between adjacent wells in a corresponding line of wells disposed in the multi-well plate. In addition, material removal heads of the invention optionally include at least one manifold, e.g., so that multiple inlets can communicate with one or more outlets. Optionally, in the systems of the invention, for example, the operable connection between the outlet and the negative pressure source includes at least one manifold. In certain embodiments, material removal heads are structured to noninvasively remove materials from a plurality of multi-well plates substantially simultaneously.

The inlets of the material removal heads disclosed herein include various embodiments. For example, the inlet optionally includes a cross-sectional shape selected from, e.g., a regular n-sided polygon, an irregular n-sided polygon, a triangle, a square, a rectangle, a trapezoid, a circle, an oval, and the like. A vacuum opening allows air to be drawn through the well and into the inlet, with the resulting air flow creating a venturi effect that effects noninvasive material removal from multi-well plates. In preferred embodiments, a cross-sectional area of the inlet is less than or equal to a cross-sectional area of a well disposed in a multi-well plate. For example, the inlet is optionally structured to noninvasively remove materials from multi-well plates that include, e.g., 6, 12, 24, 48, 96, 192, 384, 768, 1536, or more wells. Although the inlet is optionally structured to remove, e.g., solid materials from multi-well plates, in preferred embodiments, the inlet is structured to noninvasively remove fluidic material, e.g., in addition to or in lieu of solid materials.

In another aspect, the invention provides a dispensing system that includes a) at least one dispense head comprising at least one dispenser that is structured to dispense material into one or more wells of at least one multi-well plate. The dispenser is angled (e.g., between about 0° and about 90°) relative to a Z-axis so that the material is dispensed onto the sides of the wells when the dispenser is operably connected to a material source and the material is dispensed from the dispenser. As described herein, this minimizes the formation of bubbles when fluidic materials are dispensed into the wells among other advantages. In addition, the dispensing system also includes b) at least one positioning component that is structured to position one or more multi-well plates relative to the dispense head.

In yet another aspect, the present invention relates to a method of removing material from a multi-well plate. The method includes providing at least one material removal device or system that includes at least one material removal head as described herein. The material removal device or system also includes at least one negative pressure source operably connected to the outlet of the material removal head. The method also includes disposing the inlet of the material removal head proximal to at least one selected well disposed in at least one multi-well plate. In addition, the method also includes applying negative pressure from the negative pressure source such that material (e.g., fluidic material or the like) is noninvasively removed from the selected well substantially without cross-contaminating adjacent wells disposed in the multi-well plate. In some embodiments, at least one other material (e.g., cellular material or another non-fluidic material) is not removed from the selected well. Optionally, the method comprises noninvasively removing materials from a plurality of multi-well plates substantially simultaneously.

In certain embodiments, the material removal head includes at least one tip that comprises the vacuum opening, the inlet and the outlet, which tip is structured to mate with the selected well from which the material is removed. In these embodiments, the disposing step typically includes mating the tip of the material removal head with the selected well. The tip generally forms a barrier between the selected well and at least one adjacent well disposed in the multi-well plate to thereby remove the material from the selected well during the applying step substantially without cross-contaminating the adjacent well. In other embodiments, the disposing step includes contacting the material removal head with a surface of the multi-well plate. In these embodiments, the material removal head thereby typically substantially seals at least one non-selected well disposed in the multi-well plate that is not disposed proximal to the inlet so as to remove the material from the selected well during the applying step substantially without cross-contaminating the adjacent wells disposed in the multi-well plate.

Typically, the method further includes disposing the inlet proximal to at least one other selected well disposed in the multi-well plate, and applying negative pressure from the negative pressure source such that material is noninvasively removed from the other selected well. In some embodiments, the method further includes detecting a detectable signal produced in one or more wells of the multi-well plate using a detector. In preferred embodiments, the method further includes dispensing one or more materials (e.g., fluidic materials, such as buffers, wash solvents, or the like) into one or more wells using a dispenser before or after the disposing step. In some of these embodiments, the dispenser is angled (e.g., between about 0° and about 90°) relative to a Z-axis so that the materials are dispensed onto the sides of the wells, e.g., to minimize bubble formation when fluidic materials are dispensed into the wells, to prevent dispensed materials from directly impacting other materials disposed in the well, etc. These embodiments are optionally utilized, e.g., as part of high throughput washing protocols.

### BRIEF DESCRIPTION OF THE DRAWINGS

FIG. 1A schematically shows a top perspective view of a material removal head according to one embodiment of the invention.

FIG. 1B schematically depicts the material removal head of FIG. 1A from a bottom perspective view.

FIG. 1C schematically illustrates the material removal head of FIG. 1A from a top perspective view with the capture plate removed from the head.

FIG. 1D schematically shows a transparent front view of a segment of the material removal head of FIG. 1A.

FIG. 1E schematically depicts a tip from the material removal head of FIG. 1A from a bottom perspective view.

FIG. 1F schematically depicts a tip from the material removal head of FIG. 1A from another bottom perspective view.

FIG. 1G schematically illustrates a tip from the material removal head of FIG. 1A mating with a well in a multi-well plate from a top perspective view.

FIG. 1H schematically depicts a tip from the material removal head of FIG. 1A mating with a well in a multi-well plate from a cross-sectional view.

FIG. 1I schematically depicts a tip from a material removal head mating with a well in a multi-well plate from a cross-sectional view according to one embodiment of the invention.

FIG. 2A schematically shows a top perspective view of a material removal head according to one embodiment of the invention.

FIG. 2B schematically depicts the material removal head of FIG. 2A from a bottom perspective view.

FIG. 2C schematically illustrates the material removal head of FIG. 2A from an exploded bottom perspective view.

FIG. 2D schematically shows the material removal head of FIG. 2A from a cutaway, bottom perspective view.

FIG. 2E schematically depicts the material removal head of FIG. 2A from another cutaway, bottom perspective view.

FIG. 3 schematically shows one embodiment of a material removal head of the invention from a bottom perspective view.

FIG. 4A schematically depicts a hand-held material removal device from a top perspective view according to one embodiment of the invention.

FIG. 4B schematically depicts the hand-held material removal device of FIG. 4A from a bottom perspective view.

FIG. 5 schematically depicts another hand-held material removal device from a perspective view according to one embodiment of the invention.

FIG. 6A schematically illustrates one embodiment of a multi-well plate processing system from a perspective view.

FIG. 6B schematically depicts a detailed top perspective view of the material removal head and a dispense head from the system of FIG. 6A.

FIG. 6C schematically shows a detailed bottom perspective view of the material removal head and a dispense head from the system of FIG. 6A.

FIG. 7 schematically illustrates another embodiment of a multi-well plate processing system from a perspective view.

FIG. 8 schematically illustrates a representative example system for removing materials from multi-well plates in which various aspects of the present invention may be embodied.

FIG. 9 is a flowchart showing a method of removing material from a multi-well plate according to one embodiment of the invention.

### DETAILED DISCUSSION OF THE INVENTION

I. Definitions

Before describing the present invention in detail, it is to be understood that this invention is not limited to particular devices, systems, kits, or methods, which can, of course, vary. It is also to be understood that the terminology used herein is for the purpose of describing particular embodiments only, and is not intended to be limiting. Further, unless defined otherwise, all technical and scientific terms used herein have the same meaning as commonly understood by one of ordinary skill in the art to which this invention pertains. In describing and claiming the present invention, the following terminology and grammatical variants will be used in accordance with the definitions set out below.

The term “noninvasive” or “non-contact” refers to an act that does not involve penetrating or contacting a surface of material to be removed from a multi-well plate. Material surfaces typically include surfaces of fluidic and/or solid materials (e.g., dry or undissolved chemical reagents, cells, etc.). In preferred embodiments, for example, materials are noninvasively removed from multi-well plates (e.g., micro-well plates, reaction blocks, or similar containers) using the material removal heads of the invention. That is, a material removal head of the invention, or a portion thereof (e.g., a tip, a surface, etc.), does not penetrate surfaces of materials disposed in the wells of the multi-well plate when the materials are removed from the plate (e.g., even though tips of the head enter wells of the multi-well plate). In certain embodiments of the invention, for example, no portion of a material removal head penetrates a surface of a multi-well plate (e.g., does not enter a well) when it removes materials from the plate.

A material removal head inlet “communicates” with an outlet of the head when material can be translocated, e.g., from the inlet to the outlet through the head, e.g., under an applied pressure. In preferred embodiments, inlets and outlets of material removal heads fluidly communicate with one another. In embodiments of the material removal head that include multiple inlets, the head optionally includes a manifold that is structured to effect communication between outlets and inlets.

An “acute edge” refers to an edge, border, surface, or interface of an object that includes a cross-section, or an extrapolation of such a cross-section, that forms an angle that is less than 90°. In preferred embodiments, for example, an acute edge forms a sharp or knife-like edge. In other embodiments, an acute edge forms a rounded, blunt, or otherwise shaped surface that includes a cross-section that extrapolates to form an angle that is less than 90°.

A material removal head “seals” a well disposed in a multi-well plate when a portion of the head (e.g., a surface that includes inlets to the head, etc.) mates with, closes, or otherwise makes the well secure against access, leakage, or passage, e.g., by contacting a surface of the multi-well plate that includes an inlet to the well, or a tip that includes the inlet to the well itself (e.g., a top edge of the well, etc.).

A “line of wells” disposed in a multi-well plate refers to at least a subset of wells disposed in the plate, which subset includes at least one linear array of two or more wells. In certain embodiments, for example, a line of wells includes at least one column or row of wells disposed in a multi-well plate, or a subset of wells in such a row or column. In other embodiments, a line of wells includes at least a subset of wells that is disposed diagonally or otherwise in a multi-well plate. Similarly, a “line of inlets” or “line of tips” in a material removal head refers to at least a subset of inlets or tips in the head, which subset includes at least one linear array of two or more inlets or tips.

A “footprint” refers to the area on a surface covered by or corresponding to a device component or portions thereof. For example, the inlets or tips of a material removal head typically correspond to (e.g., match, align with, etc.) selected wells in one or more multi-well plates. In some embodiments, the correspondence is one-to-one (e.g., one inlet or tip per each well in a multi-well plate, etc.), but is also optionally otherwise (e.g., multiple inlets or tips per each well in a multi-well plate, multiple wells in a multi-well plate per inlet or tip, etc.). In preferred embodiments of the invention, for example, the inlets or tips of a material removal head described herein include a footprint that corresponds to a selected subset of wells disposed in a multi-well plate (e.g., corresponding to all, or less than all, wells in one or more lines of wells disposed in a plate, etc.), such that at least subsets of these inlets or tips and wells axially align with one another (e.g., to communicate with one another, etc.).

The term “top” refers to the highest point, level, surface, or part of a device, or device component, when oriented for typical designed or intended operational use, such as removing material from a well of a multi-well plate. In contrast, the term “bottom” refers to the lowest point, level, surface, or part of an apparatus, or apparatus component, when oriented for typical designed or intended operational use.

II. Material Removal Heads and Devices

While the present invention will be described with reference to a few specific embodiments, the description is illustrative of the invention and is not to be construed as limiting the invention. Various modifications to the present invention can be made to the preferred embodiments by those skilled in the art without departing from the true scope of the invention as defined by the appended claims. It is noted here that for a better understanding, certain like components are designated by like reference letters and/or numerals throughout the various figures.

In overview, the material removal heads and devices of the invention may be used essentially any time fluids or other materials are to be reliably removed from multi-well plate wells. These noninvasive or non-contact devices avoid many of the problems associated with pre-existing devices, including device plugging and cross-contamination among wells. Materials can be removed from many wells of multi-well plates before the material removal heads of the invention are washed, since the materials are noninvasively removed from the wells (i.e., without the heads, or portions thereof, penetrating surfaces of well contents). This significantly decreases the cycle time for removing materials from a multi-well plate relative to cycle times achievable with pre-existing devices, especially as most pre-existing devices are washed numerous times during each cycle.

The invention also provides dispense heads and related systems. The dispense heads of the invention can be used alone or in combination with the materials removal heads described herein. Dispense heads and systems are described further below.

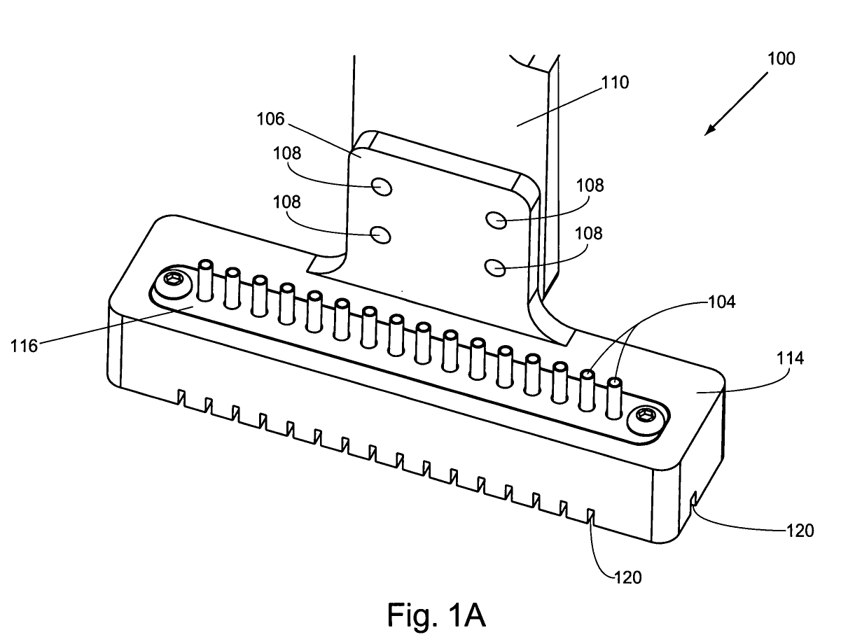

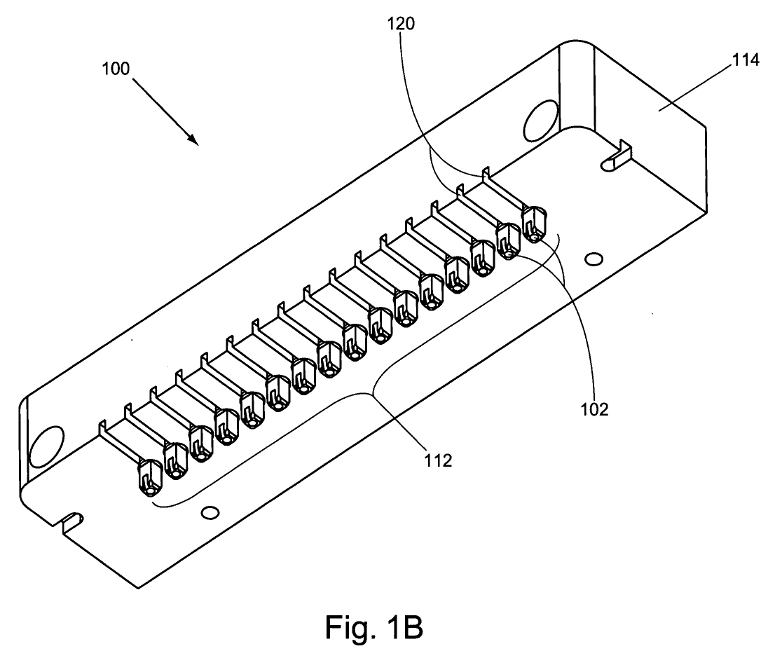

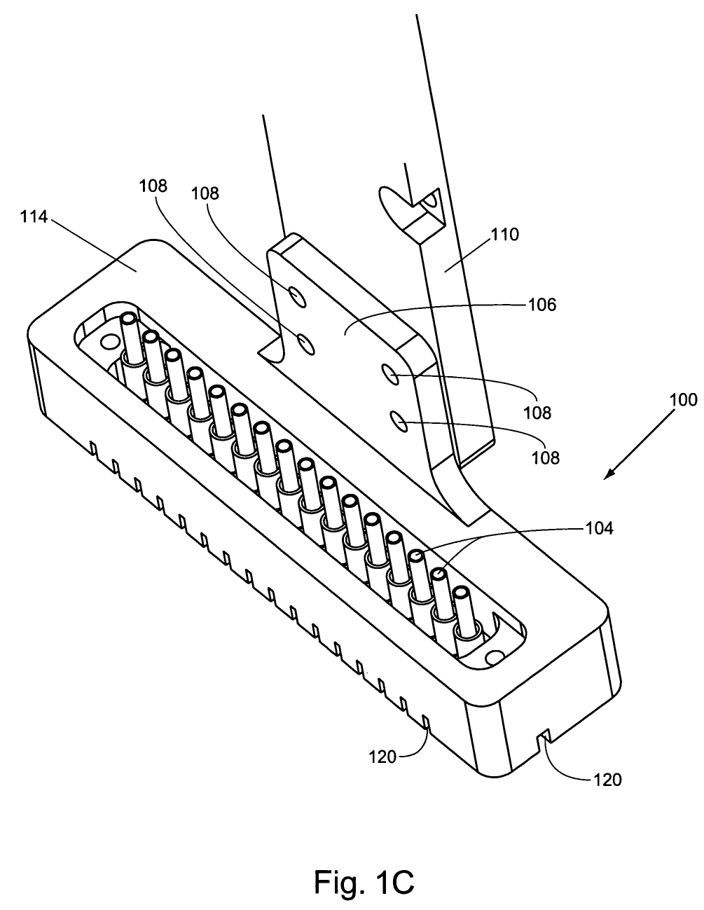

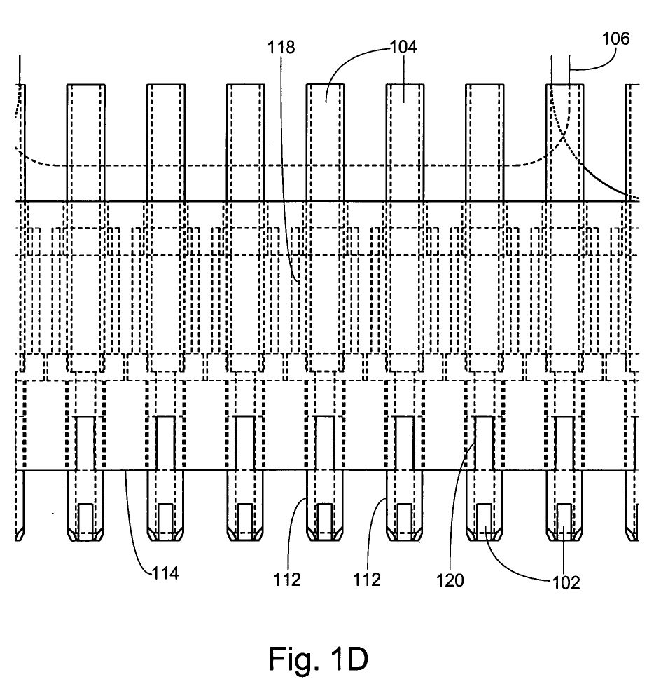

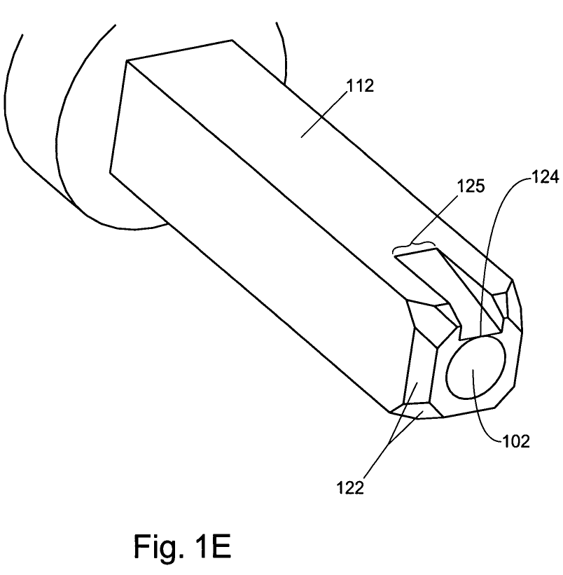

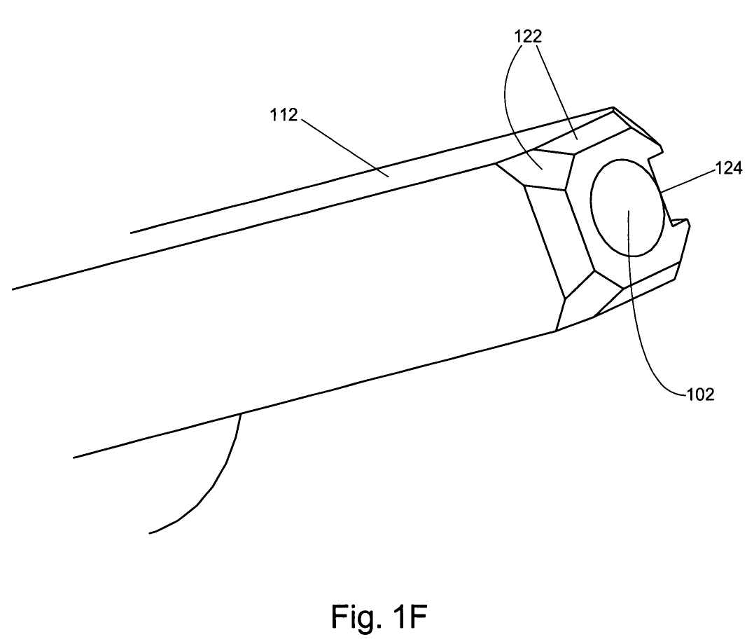

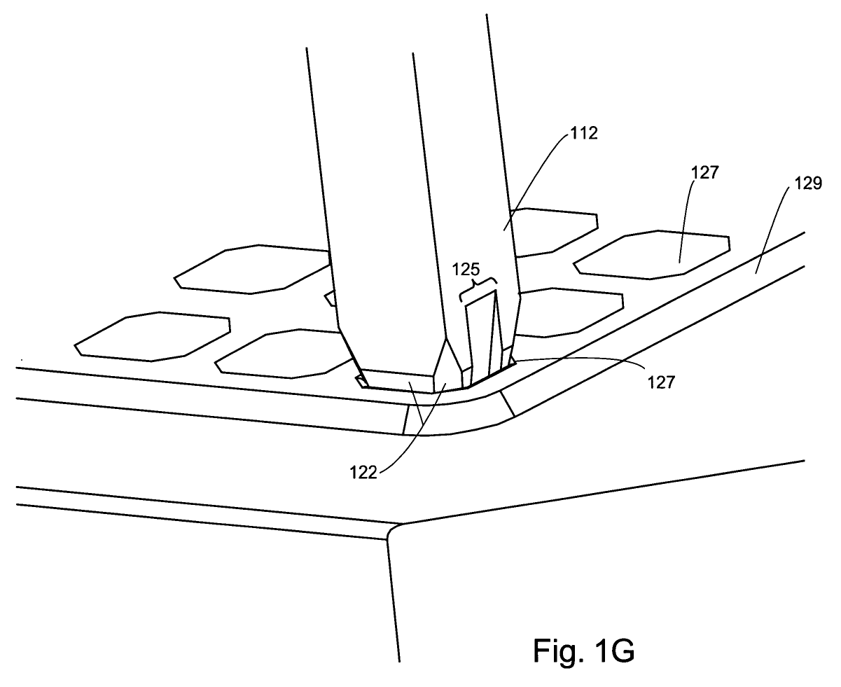

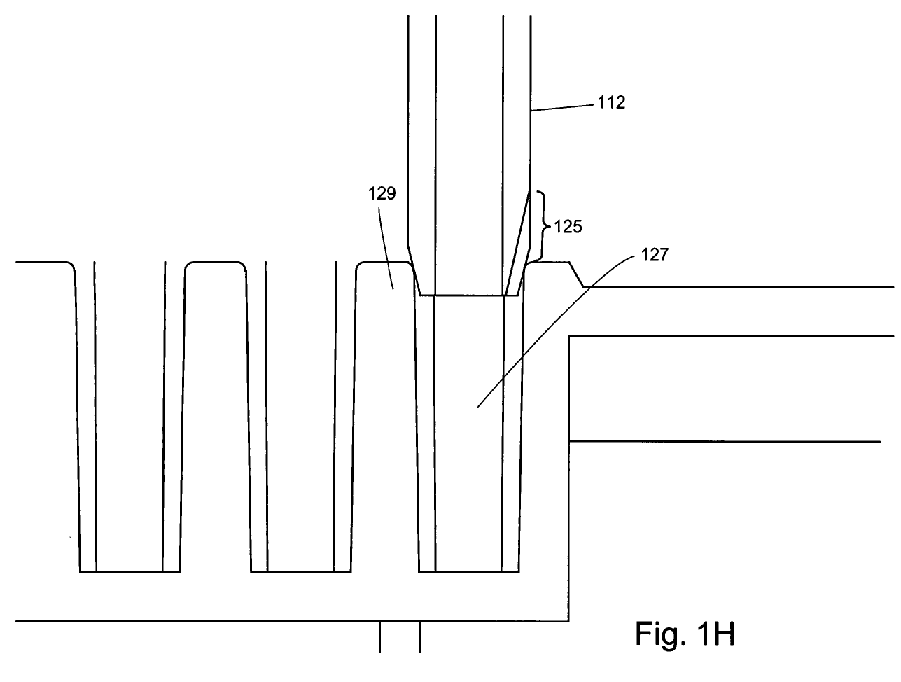

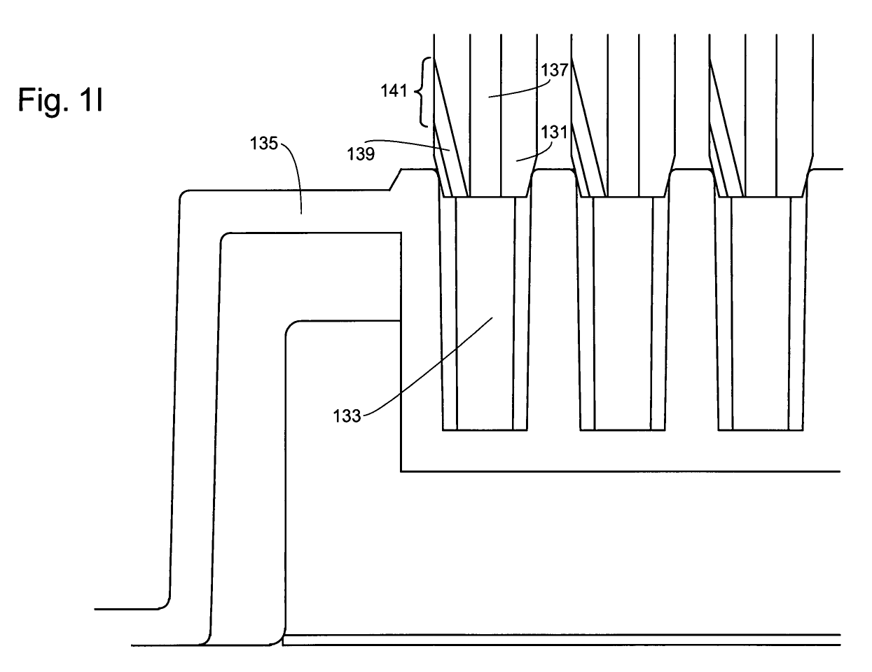

Referring initially to FIGS. 1A and B, which schematically illustrate an embodiment of a material removal head of the present invention from various views. More specifically, FIG. 1A schematically shows a top perspective view of material removal head 100 according to one embodiment of the invention, while FIG. 1B schematically depicts material removal head 100 from a bottom perspective view. As shown, material removal head 100 includes tips 112, each of which tips includes an inlet 102 that communicates with an outlet 104. In the embodiment shown, each inlet 102 communicates with a separate outlet 104. Optionally, the material removal heads of the invention are fabricated such that multiple inlets communicate with the same outlet. That is, material removal heads are optionally fabricated to comprise one or more manifolds. Some of these embodiments are described further below. Tips 112 of material removal head 100 are structured to noninvasively remove materials from wells disposed in multi-well plates when outlets 104 are operably connected (e.g., via flexible tubes or other conduits) to one or more negative pressure sources (not shown). Negative pressure sources are described in greater detail below. As further shown in FIG. 1, material removal head 100 also includes mounting bracket 106, which includes holes 108 through which screws, bolts, rivets, or other fastening devices are inserted to attach material removal head 100 to another device or system component, such as translation arm 110 that moves material removal head 100 relative to multi-well plates, material removal head washing components, etc. Other methods of attaching material removal heads to other device or system components are described herein or are otherwise known in the art.

In the embodiment schematically depicted in FIG. 1, tips 112 of material removal head 100 that include inlets 102 extend from body structure 114 of material removal head 100. Tips 112 are typically vacuum tips or the like having channels or other cavities disposed therethrough. Optionally, the tips are fabricated as integral components of material removal heads (e.g., as a single molded part, etc.) or as separate components of material removal head, which are positioned in a separately fabricated body structure of material removal head during device assembly. Fabrication techniques are described further below. As shown in FIG. 1, the tips 112 are schematically illustrated as separate components. In particular, referring to FIGS. 1C and D, which schematically illustrate material removal head 100 from a top perspective view with capture plate 116 removed from material removal head 100, and a transparent front view of a segment of material removal head 100, respectively. Capture plate 116 is utilized in the embodiment shown to align and retain the tips in position relative to the body structure of material removal head 100 in the assembled head. In preferred embodiments of the invention, tips 112 are resiliently coupled to the body structure 114 by resilient couplings 118 having selected flexures or tensions, e.g., to account for well-to-well and plate-to-plate variations and to prevent the tips and/or multi-well plates from being damaged when they are contacted during material removal processes. Essentially any type of resilient coupling can be adapted for use in these embodiments. Exemplary resilient couplings include springs, elastomeric materials or other compressible solids, and compressible gases and/or fluids. In certain embodiments, resilient couplings 118 are not included in material removal head 100. In these embodiments, for example, resiliency is optionally designed into other device or system components to which material removal head 100 is attached and/or into multi-well plate positioning components.

As further shown in FIG. 1E, tips 112 of the material removal head 100 include vent openings 125, through which air drawn when a negative pressure source is applied to the outlet. Air flows through the vent opening into the inlet, thereby creating a venturi effect in the well which effects noninvasive removal of materials from the well. The material removal head can also include vent openings (120 in FIGS. 1A-1D); these vent openings in the material removal head are aligned with the vent openings 125 in the tips.

In preferred embodiments of the invention, tips 112 are structured to mate with wells (e.g., top edges of openings to wells, etc.) from which material is to be removed such that the tip forms a barrier between the well and one or more adjacent wells, thereby preventing cross contamination from occurring among the wells of the multi-well plate being processed. Examples of tips that are designed to mate with and seal multi-well plate wells are further schematically illustrated in FIGS. 1E and F, which depict tip 112 from material removal head 100 from bottom perspective views. As shown, tip 112 includes inlet 102 and angled surfaces 122. Angled surfaces 122 are designed to mate with the top edges of well openings to seal the wells. At least one of the angled surfaces is interrupted by a vent opening 125 that permits air to pass into the well when a vacuum is applied to the outlet. The remaining angled surfaces contact the sides of the well and form a barrier between the well from which material is to be removed and at least one adjacent well. To illustrate, FIGS. 1G and H schematically depict tip 112 from material removal head 100 mating with well 127 in multi-well plate 129 from top perspective and cross-sectional views, respectively. In some embodiments, tips include one or more acute edges that delineate one side of the opening. As shown in FIGS. 1E and F, for example, inlet 102 of the tip includes acute edge 124, which separates the inlet from the vent opening. The use of an acute edge can maximize the size of the inlet and vent opening in the tip. Optionally, acute edges are not included in the material removal heads described herein. Additional details regarding the tips and acute edges of the material removal heads of the invention are provided below.

Tips are optionally fabricated to mate with any well shape. For example, a tip 112 of material removal head 100 optionally includes a cross-sectional shape selected from, e.g., a regular n-sided polygon, an irregular n-sided polygon, a triangle, a square, a rectangle, a trapezoid, a circle, an oval, etc. In addition, tips are optionally designed to extend any distance into multi-well plate wells upon mating as long as they do not penetrate or contact surfaces of materials to be removed from the wells. For example, tips typically extend less than about 0.5 mm into multi-well plate wells upon mating with the plate, more typically they extend less than about 0.4 mm into multi-well plate wells upon mating with the plate, and still more typically they extend less than about 0.3 mm into multi-well plate wells upon mating with the plate (e.g., 0.2 mm, 0.1 mm, etc.).

In an alternative embodiment, the tip includes a seal that contacts the multi-well plate and forms the barrier between the well from which the material is to be removed and one or more adjacent wells. The seal can be formed of rubber (e.g., silicon rubber) or other compliant material. The tip includes a vent opening on at least one side of the tip (e.g., a recess in the tip that leaves a gap between the tip and the seal) to allow air to pass through the opening and into the well when a vacuum is applied to the outlet, e.g., to effect noninvasive removal of materials from the well. One embodiment of such a recess (i.e., opening 125) is schematically illustrated in FIG. 1E.

Another example of this type of tip includes two tubes, preferably formed of a rigid material, that are placed side-by-side. The diameters of the tubes are such that both tubes can fit into a well of a multi-well plate. Alternatively, one tube can be placed inside a second tube. One tube serves as the vent opening and the other tube includes the inlet on one end and the outlet on the other end. To illustrate one of these embodiments, FIG. 11 schematically shows tip 131 from a material removal head mating with well 133 in multi-well plate 135 from a cross-sectional view. As shown, tip 131 includes first tube 137, which communicates with well 133 and an outlet (not shown) to tip 131, and second tube 139, which communicates with well 133 and vent opening 141 of tip 131. A seal material, such as a gasket, is optionally disposed around the tubes so that when the tip is disposed proximal to a well of a multi-well plate the gasket seals the well from which materials are to be removed, forming a barrier between this well and adjacent wells, thereby reducing or eliminating cross-contamination. The material removal head can include a support that holds one or more of these tips, spaced appropriately for the multi-well plate. In some embodiments, each tip can include three tubes, one of which is a dispenser operably connected to a reservoir that contains fluid that is to be dispensed into the wells.

The arrangement of tips, which include the inlets of the material removal heads of the invention, include various embodiments. In preferred embodiments, material removal heads include multiple tips, e.g., to increase the throughput of material removal processes relative to those performed with devices having only single tips. In FIG. 1, for example, material removal head 100 includes 16 tips 112 that are spaced at distances from one another so as to simultaneously mate, e.g., with every other well in a 32-well row of a 1536-well plate.

In one illustrative embodiment, removal of material from a 1536-well plate using this particular embodiment of material removal head involves placing the material removal head such that the tips contact every other well in the first row. The vent opening in the tips face an edge of a plate (i.e., the openings do not face any adjacent wells of the plate). The tips form a barrier between these wells and all adjacent wells. A vacuum is applied to the outlets, thereby drawing air through the vent openings into the inlet and removing materials from the wells. No cross-contamination of adjacent wells occurs because of the barriers formed by the tips. The material removal head or the multi-well plate is then moved such that the tips mate with the wells of the first row from which material has not yet been removed. Again, the vent openings face the edge of the plate and not any adjacent wells. A vacuum is applied to the outlets, thereby removing materials from these wells. The material removal head or the plate is then moved such that the tips mate with every other well of the second row of wells. The vent openings in the tips now face the first row of wells, from which materials have already been removed. The tips form barriers between the wells from which material is to be removed and the adjacent material-containing wells, thereby preventing cross-contamination of the adjacent wells. A vacuum is applied to the outlets, drawing air through the vent openings and into the inlets, thereby removing the materials from the wells with which the tips are mated. This process is repeated as required until material is removed from all desired wells. By positioning the plate and material removal head such that the vent openings in the tip never face an adjacent well that contains a material to be removed, cross-contamination is greatly reduced or eliminated.

The tips of material removal heads are optionally configured to mate with plates having different numbers of wells than 1536-well plates. Further, they can be configured to simultaneously mate with any number of wells in those plates (e.g., every well in a given row or column, wells in multiple rows or columns, every well of the particular plate, etc.). In some embodiments, tips are configured to simultaneously mate with wells disposed in multiple multi-well plates.

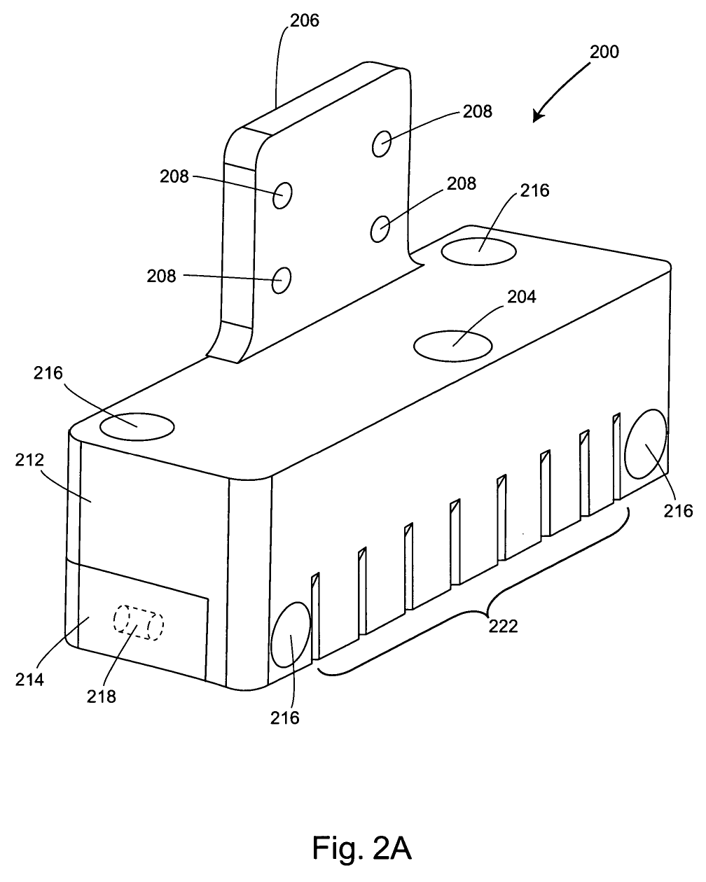

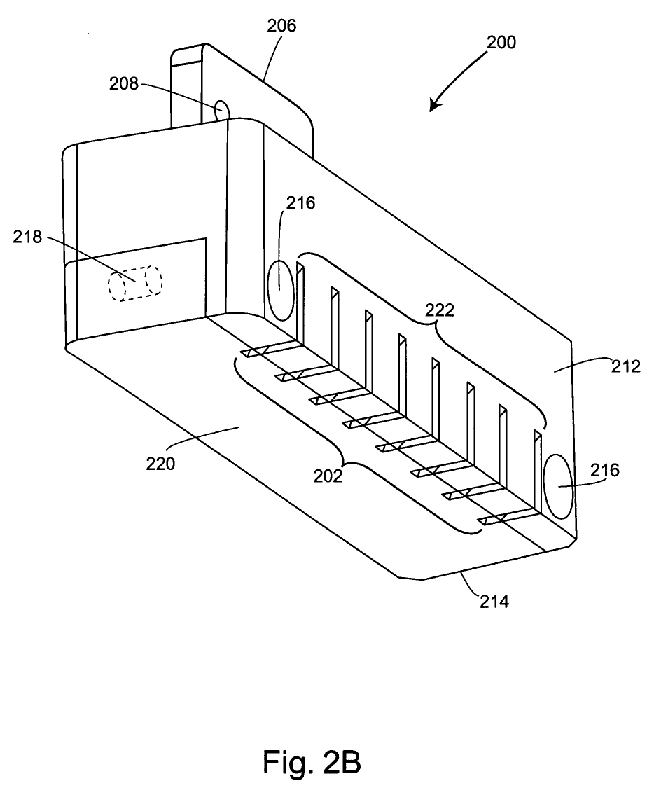

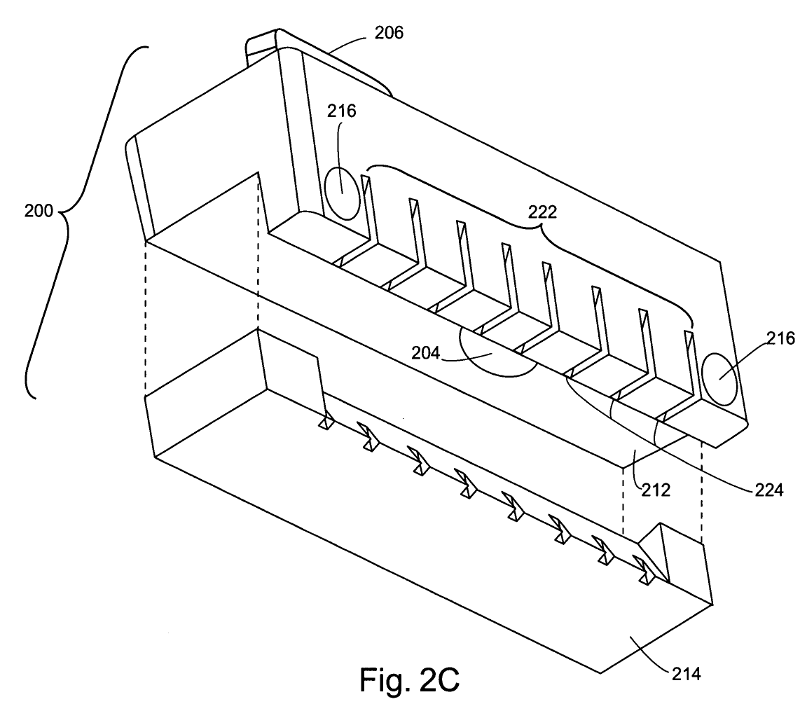

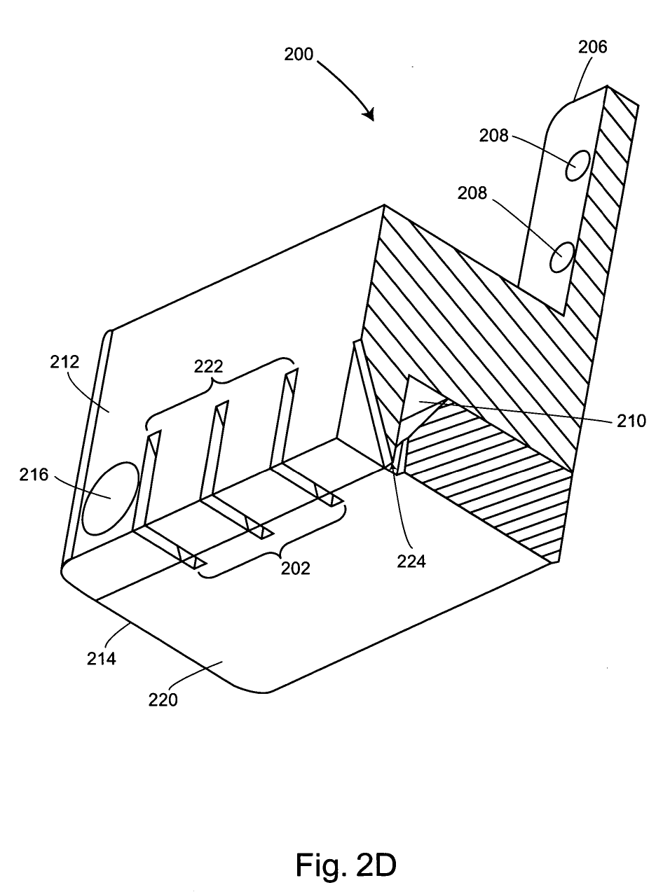

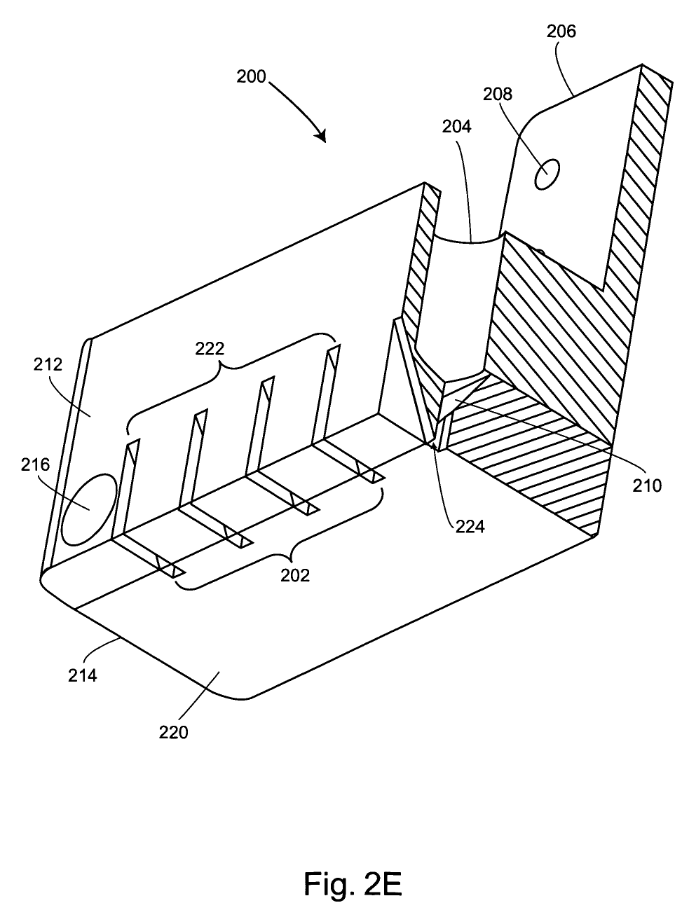

Referring now to FIGS. 2A-E, which schematically show another embodiment of a material removal head of the invention from various views. In particular, FIG. 2A schematically depicts material removal head 200 from a top perspective view, while FIG. 2B schematically illustrates material removal head 200 from a bottom perspective view. In addition, FIG. 2C schematically shows material removal head 200 from an exploded bottom perspective view. As shown, material removal head 200 includes inlets 202 through which materials are noninvasively removed from multi-well plates when material removal head 200 is included in a device or system of the invention. As also shown, material removal head 200 includes outlet 204 disposed through a top surface of material removal head 200. In material removal device or system of the invention, outlet 204 is typically operably connected to a negative pressure source via one or more tubes or other conduits so that the negative pressure source can apply negative pressure through inlets 202. Negative pressure sources are described further below. Optionally, the material removal heads of the invention include multiple outlets (e.g., 2, 3, 4, 5, or more outlets). In some embodiments of the invention, for example, a material removal head includes one outlet for each inlet (i.e., pairs of corresponding inlets and outlets). Further, the outlets are also optionally disposed through surfaces other than top surfaces of the material removal heads. As additionally shown in FIG. 2, material removal head 200 includes mounting bracket 206 having holes 208 through which screws, bolts, or the like are inserted to mount material removal head 200 to another system component, such as a Z-axis or multiple-axis translation arm or component that moves material removal head 200 relative to multi-well plates, material removal head washing components, or the like. Optionally, material removal heads are fastened, bonded, welded, or otherwise attached to other systems components. In some embodiments, material removal heads are fabricated integral with other system components. Material removal systems of the invention are described in greater detail below.

Material removal head outlets typically communicate (e.g., fluidically or the like) with the inlets. As shown in FIG. 2, for example, outlet 204 and inlets 202 together form a manifold such that materials drawn into material removal head 200 inlets 202 are directed towards outlet 204. This is further illustrated in FIGS. 2D and E, which schematically show different cutaway, bottom perspective views of material removal head 200. As shown, inlets 202 and outlet 204 communicate with one another via cavity 210. Each inlet is fluidically connected to an opening that serves as a vent through which air is drawn when a negative pressure is applied to the outlet. For example, as shown in FIG. 2B, angled notches 222 are fabricated into top head component 212 to allow air to be drawn through the inlet. In some embodiments, at least a section of an inlet includes an acute edge (e.g., a knife-edge or the like). Examples of acute edges are schematically shown in FIG. 2. As shown, angled notches 222 are fabricated into top head component 212 to form acute edges 224, which edges form sections (e.g., one of the four sides of each inlet depicted) of inlets 204 when top and bottom head components 212 and 214 are assembled.

The material removal heads of the invention are optionally fabricated as single integral units. In preferred embodiments, material removal heads are assembled from individually fabricated component parts. For example, this is schematically illustrated in FIG. 2, which shows material removal head 200 assembled from two component parts, namely, top head component 212 and bottom head component 214. Material removal heads are optionally fabricated from more than two components. Upon assembly, head components are fastened to one another using essentially any fastening techniques, including adhering, bonding, clamping, welding, screwing, bolting, etc. As shown in FIG. 2, for example, top and bottom head components 212 and 214 are fabricated with fastener receiving elements 216 and 218, which are structured to receive screws, bolts, or the like (not shown). As further shown in FIG. 2, when assembled, top and bottom head components 212 and 214 form inlets 202 and cavity 210. In some embodiments, inlets, outlets, cavities, etc. are fabricated entirely in one material removal head component. This is illustrated, for example, in FIG. 2 in which outlet 204 is fabricated entirely in top head component 212.

In preferred embodiments of this type of material removal head, a surface of a material removal head that includes the inlet or inlets is structured to substantially seal at least one other well in the multi-well plate when the inlet or inlets are disposed proximal to the well or wells from which materials are to be removed. In these embodiments, this surface of the material removal head is generally substantially flat. For example, this is illustrated in FIG. 2, which shows bottom surface 220 of material removal head 200 structured to substantially seal certain wells of a multi-well plate other than those that are aligned with inlets 202 at the point when materials are removed from the multi-well plate. More specifically, bottom surface 220 seals these other wells by covering them when inlets 202 are disposed proximal to the wells of the multi-well plate from which the materials are to be removed. One advantage of substantially sealing these other wells is to prevent cross-contamination among wells in the multi-well plate, e.g., when materials are removed from the plate.

The inlets of the material removal heads of the invention include various embodiments. For example, a material removal head of the invention typically includes multiple inlets (e.g., 2, 3, 4, 5, 6, 7, 8, 9, 10, or more inlets). To further illustrate, a material removal head as described herein typically includes at least 2 inlets, more typically at least 8 inlets, and still more typically at least 16 inlets. As shown in FIG. 1, for example, material removal head 100 includes 16 inlets 102, whereas in FIG. 2 material removal head 200 includes 8 inlets 202. Inlets optionally include cross-sectional shapes selected from, e.g., a regular n-sided polygon, an irregular n-sided polygon, a triangle, a square, a rectangle, a trapezoid, a circle, an oval, and the like. Although a cross-sectional area of an inlet is optionally more that a cross-sectional area of a well disposed in a multi-well plate, in preferred embodiments, a cross-sectional area of an inlet is less than a cross-sectional area of a well disposed in a multi-well plate. Additionally, inlets are optionally structured to noninvasively remove materials from multi-well plates that include, e.g., 6, 12, 24, 48, 96, 192, 384, 768, 1536, or more wells. Although inlets are optionally configured to remove, e.g., solid materials from multi-well plates, in preferred embodiments, the inlet is configured to noninvasively remove fluidic material or both solid and fluidic materials.

In preferred embodiments, material removal heads include at least two inlets that are spaced at a distance that substantially corresponds to a distance between at least two wells disposed in a multi-well plate. To illustrate, material removal heads typically include a plurality of inlets in which centers of at least two of the inlets are spaced 18 mm, 9 mm, 4.5 mm, 2.25 mm, or less apart from one another so that they correspond to the center-to-center spacing between adjacent wells in, e.g., 24-, 96-, 384-, or 1536-well micro-well plates, respectively. Other lower or higher density configurations are also optionally utilized. For example, the inlets can be spaced such that they correspond to the center-to-center spacing between every other well, or every third or fourth well, in a row or column of wells. To further illustrate, material removal heads optionally include a plurality of inlets at least a subset of which include a footprint that substantially corresponds to a footprint of at least a subset of at least one line of wells disposed in a multi-well plate. A material removal head for use with a 1536-well plate, for example, can include 16 inlets having a center-to-center spacing equal to the spacing between every other well in a 32-well row of a 1536-well plate. In these embodiments, the number of spacing regions disposed between adjacent inlets in a line of inlets is typically a multiple of the number of spacing regions disposed between adjacent wells in a corresponding line of wells disposed in the multi-well plate. In certain embodiments, material removal heads are structured to noninvasively remove materials from a plurality of multi-well plates substantially simultaneously. To illustrate, the inlets of a material removal head of the invention optionally include a footprint that corresponds to the footprint of at least a subset of wells disposed in multiple multi-well plates, e.g., when those plates are positioned next to one another.

When material removal head 200 is lowered, e.g., onto a first column or row of wells to be cleaned or from which materials are to be removed in a multi-well plate, surrounding wells except for those to be cleaned or from which materials are to be removed are sealed, as described above, by the bottom surface of the material removal head. When a negative pressure is applied to the inlets, e.g., by opening a solenoid valve to open a vacuum line that is operably connected to an outlet of the material removal head, air is sucked into the material removal head through the vent opening. As the fast moving air is pulled into the material removal head, it also pulls up fluids or other materials (e.g., depending upon the selected applied pressure strength) from the wells. Since the surrounding wells are substantially sealed by the bottom surface of the material removal head, during this process, no cross-contamination occurs among wells disposed in the multi-well plate. When the fluid or other materials have been removed from the wells, the solenoid valve turns off vacuum flow from the negative pressure source.

In an illustrative embodiment, materials are removed first from a row of wells that are adjacent to an edge of a multi-well plate. The vent openings face the edge of the plate, away from adjacent wells. A vacuum is applied to the outlet, thereby removing the materials from the wells that are proximal to the inlets. Once materials are removed from the wells that are proximal to the inlets, either the material removal head or the plate is moved such that the inlets are now proximal to wells from which materials have not yet been removed (e.g., wells in the next row of wells). Adjacent wells that contain materials are substantially sealed by the material removal head to prevent cross-contamination, and the vent openings face the wells from which materials have already been removed. By sequentially moving across the plate in this manner, one can remove materials from each well without cross-contaminating other wells.

To further illustrate, FIG. 1 also schematically shows that inlet 102 of tip 112 includes acute edge 124, which directs air into material removal head 100 when the tip is mated with the well from which material is to be removed, as described above. Other acute edge configurations are also possible. In certain embodiments, for example, multiple sections of a given inlet disposed in a material removal head include acute edges. Optionally, different inlets in a particular material removal head include different acute edge configurations. In certain other embodiments of the invention, inlets lack acute edges (e.g., because notches or the like are not fabricated into material removal heads).

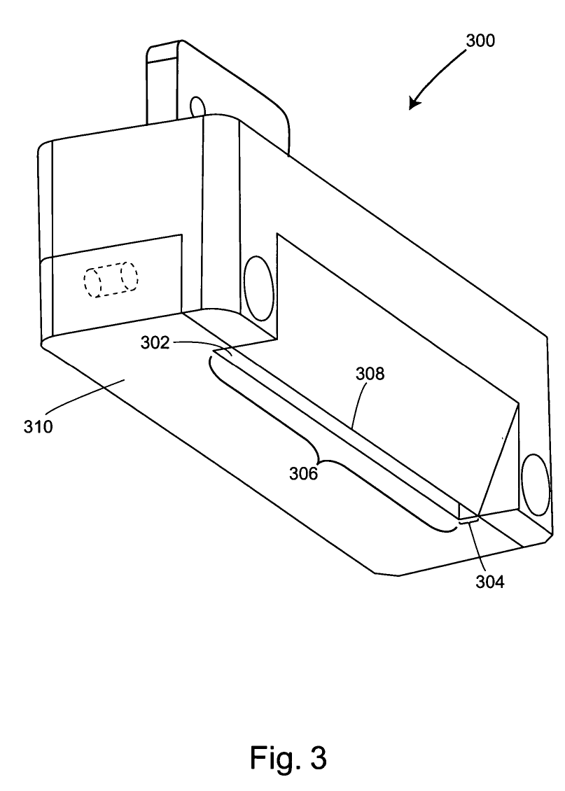

The material removal heads of the invention include many related embodiments. To illustrate, the external dimensions of material removal heads are optionally varied. In certain embodiments, for example, at least portions of material removal heads (e.g., surfaces that include inlets, tips, etc.) have footprints that substantially correspond to a footprint of a multi-well plate or a portion of such a plate. Optionally, material removal heads include footprints that substantially correspond to a footprint formed by multiple multi-well plates or selected portions of such plates taken together. In addition, numbers, dimensions, shapes, etc. of inlets and/or outlets can also be varied. For example, FIG. 3 schematically shows another embodiment of a material removal head of the invention from a bottom perspective view. In particular, material removal head 300 includes inlet 302 and an outlet (not within view) that communicate with one another. Inlet 302 typically includes first cross-sectional dimension 304 (e.g., a width of inlet 302) that is less than a first cross-sectional dimension of at least one well disposed in at least one multi-well plate. Inlet 302 also typically includes second cross-sectional dimension 306 (e.g., a length of inlet 302) that substantially corresponds to at least a portion of a length of at least one line of wells disposed in the multi-well plate. Inlet 302 is structured to noninvasively remove material from one or more wells disposed in a line of wells when the outlet is operably connected to at least one negative pressure source. A vent opening is formed by, for example, an acute edge 308 of inlet 302, which is structured to direct airflow into material removal head 300 through inlet 302 when a negative pressure is applied to create a vacuum in the wells from which materials are removed. In addition, surface 310 of material removal head 300 that includes inlet 302 is structured to substantially seal at least one other well in a multi-well plate when inlet 302 is disposed proximal to the well from which the material is to be removed. To further illustrate, second cross-sectional dimension 306 of inlet 302 is optionally fabricated to substantially correspond to a row or column length line of wells disposed in a multi-well plate. As an additional option, second cross-sectional dimension 306 is fabricated to substantially correspond to a row or column length line or wells disposed in multiple multi-well plates, e.g., when those plates are positioned or aligned next to or otherwise proximal to one another such that materials can be removed from wells disposed in more than one plate at the same time.

Material removal head components and other components of the devices and systems described herein are fabricated from materials or substrates that are generally selected according to properties, such as reaction inertness, durability, expense, or the like. In certain embodiments, for example, material removal head components are fabricated from various polymeric materials such as, polytetrafluoroethylene (TEFLON™), polypropylene, polystyrene, polysulfone, polyethylene, polymethylpentene, polydimethylsiloxane (PDMS), polycarbonate, polyvinylchloride (PVC), polymethylmethacrylate (PMMA), or the like. Polymeric parts are typically economical to fabricate, which affords material removal head or component disposability (i.e., replacing the material removal head or component without replacing other device or system components, such as multi-well plate storage components, washing components, etc.). Material removal heads or component parts are also optionally fabricated from other materials including, e.g., glass, metal (e.g., stainless steel, anodized aluminum, etc.), silicon, or the like. For example, material removal heads are optionally assembled from a combination of materials permanently or removably joined or fitted together, e.g., polymer or glass top head components with stainless steel bottom head components, etc.

The material removal heads or components are optionally formed by various fabrication techniques or combinations of such techniques including, e.g., injection molding, cast molding, machining, embossing, extrusion, etching, or other techniques. These and other suitable fabrication techniques are generally known in the art and described in, e.g., Rosato, Injection Molding Handbook, 3^{rd} Ed., Kluwer Academic Publishers (2000), Fundamentals of Injection Molding, W. J. T. Associates (2000), Whelan, Injection Molding of Thermoplastics Materials, Vol. 2, Chapman & Hall (1991), Fisher, Extrusion of Plastics, Halsted Press (1976), and Chung, Extrusion of Polymers: Theory and Practice, Hanser-Gardner Publications (2000). After material removal head or component part fabrication, the heads or components thereof, such as top and bottom head components, body structures, tips, inlets, outlets, cavities, etc., are optionally further processed, e.g., by coating surfaces with, e.g., a hydrophilic coating, a hydrophobic coating, or the like.

A material removal device of the invention includes at least a negative pressure source operably connected to an outlet of a material removal head. Essentially any negative pressure source is optionally utilized in the devices of the invention to effect material removal from multi-well plates as described herein. In preferred embodiments, for example, negative pressure sources include pumps, such as vacuum or centrifugal blower pumps that can create suction forces. Many different pumps of this nature are known in the art and are commercially available from various sources. In preferred embodiments, a negative pressure source applies a pressure of at least 28.5 inches Hg at the inlet at a flow rate of at least 0.3 cubic feet per minute. At least one tube or other conduit typically operably connects negative pressure sources to material removal head outlets in the devices of the invention. Further, at least one valve (e.g., a solenoid valve, etc.) is typically operably connected to the material removal device, which valve regulates pressure flow from the negative pressure source. In addition, at least one trap is optionally operably connected to the material removal device, which trap is structured to trap waste material or the like that is removed from multi-well plates as described herein.

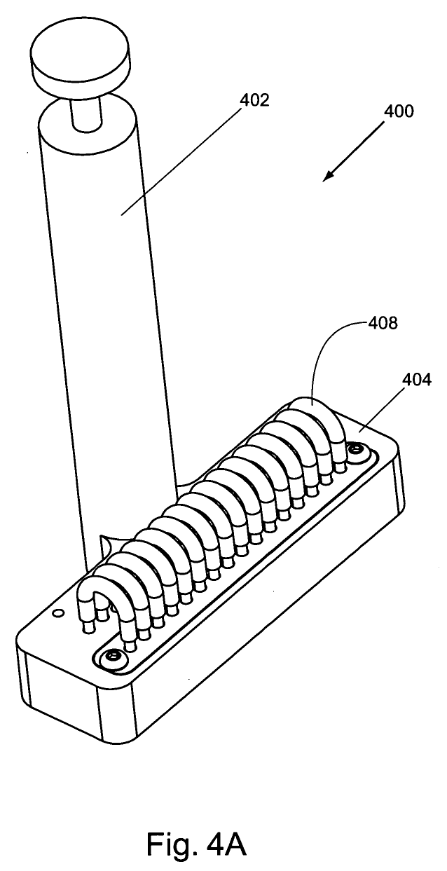

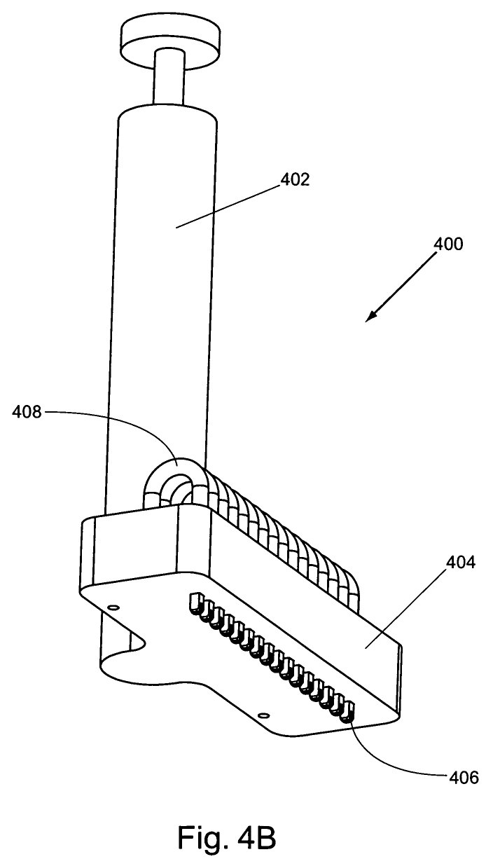

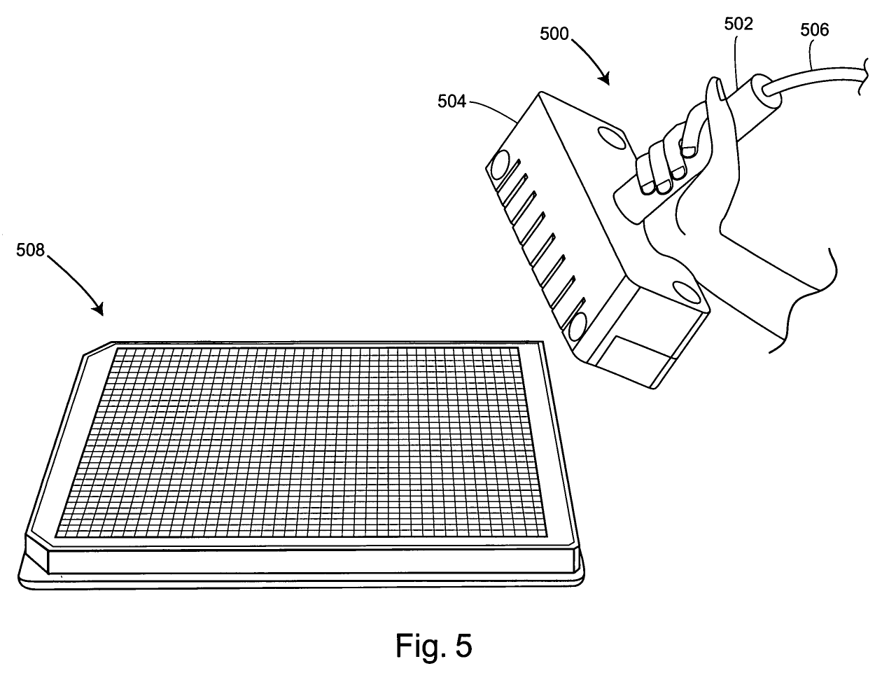

Material removal devices of the invention include various embodiments. In certain embodiments, for example, material removal devices are hand-held, whereas in others, material removal devices are included in stand-alone material removal or wash stations or as components of other systems (e.g., automated screening systems or the like). To illustrate, FIGS. 4A and B schematically depict a hand-held material removal device from top and bottom perspective views, respectively, according to one embodiment of the invention. As shown, hand-held material removal device 400 includes handle 402 attached to material removal head 404. As also shown, material removal head 404 includes tips 406 that communicate with a negative pressure source that is integral with handle 402 via tube 408. To further illustrate, FIG. 5 schematically depicts a hand-held material removal device from a perspective view according to another embodiment of the invention. As shown, hand-held material removal device 500 includes handle 502 attached to material removal head 504. In the embodiment shown, tube 506 is disposed through handle 502 to communicate with an outlet of material removal head 504. Although not shown, tube 506 is also operably connected to a negative pressure source. During operation, a user contacts a surface of hand-held material removal device 500 that includes the inlets with a surface of multi-well plate 508 that includes the wells and moves the inlets over wells from which materials are to be removed. Other material removal device embodiments, including systems are described further below.

III. Multi-Well Plate Processing Systems

The invention also provides multi-well plate processing systems that can rapidly remove materials from selected wells of micro-well plates, e.g., as part of a high-throughput screening or washing procedure. These systems, which are typically highly automated, include at least one material removal component that includes at least one negative pressure source, such as a vacuum pump, centrifugal blower, or the like in addition to at least one material removal head as described herein. Negative pressure sources are typically operably connected to material removal heads via tubes or other conduits such that negative pressure can be applied at inlets to the material removal heads by the negative pressure source to effect noninvasive material removal from multi-well plates. Negative pressure sources and material removal heads that are optionally utilized in the systems of the invention are described in greater detail above. Multi-well plate processing systems also include positioning components, dispensing components, or both positioning and dispensing components. In certain embodiments, the systems of the invention include positioning and dispensing components, but do not include the material removal components described herein. Positioning components are structured to position one or more multi-well plates relative to the material removal component, whereas dispensing components are structured to dispense materials (e.g., fluidic materials, etc.) into selected wells of multi-well plates. For example, dispensing components typically include at least one dispenser that aligns with wells disposed in one or more multi-well plates when the multi-well plates are disposed proximal to the dispenser. Various other components are also optionally included in the systems of the present invention. Certain of these are described further below.

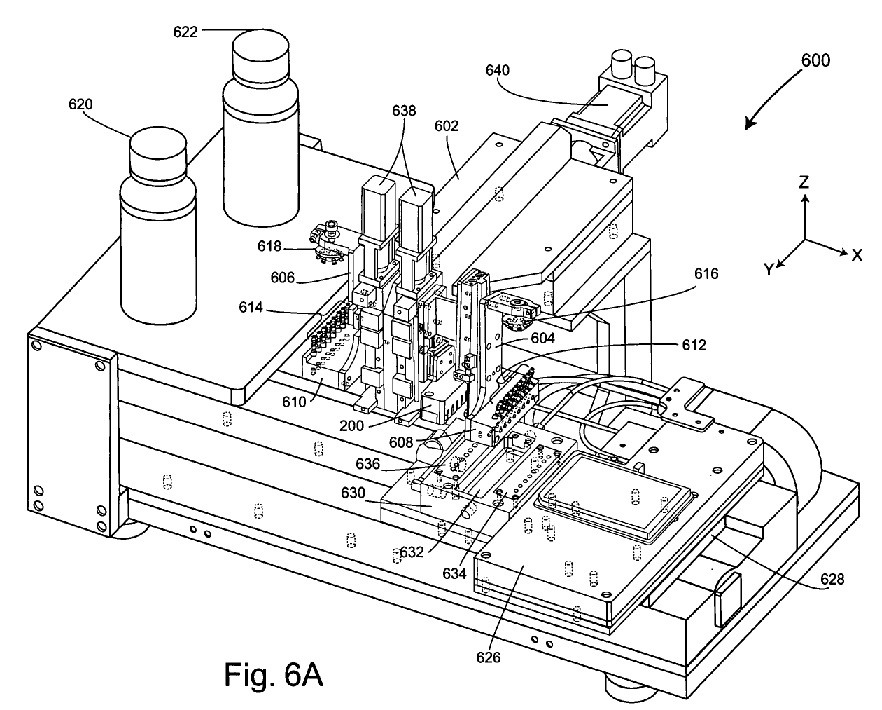

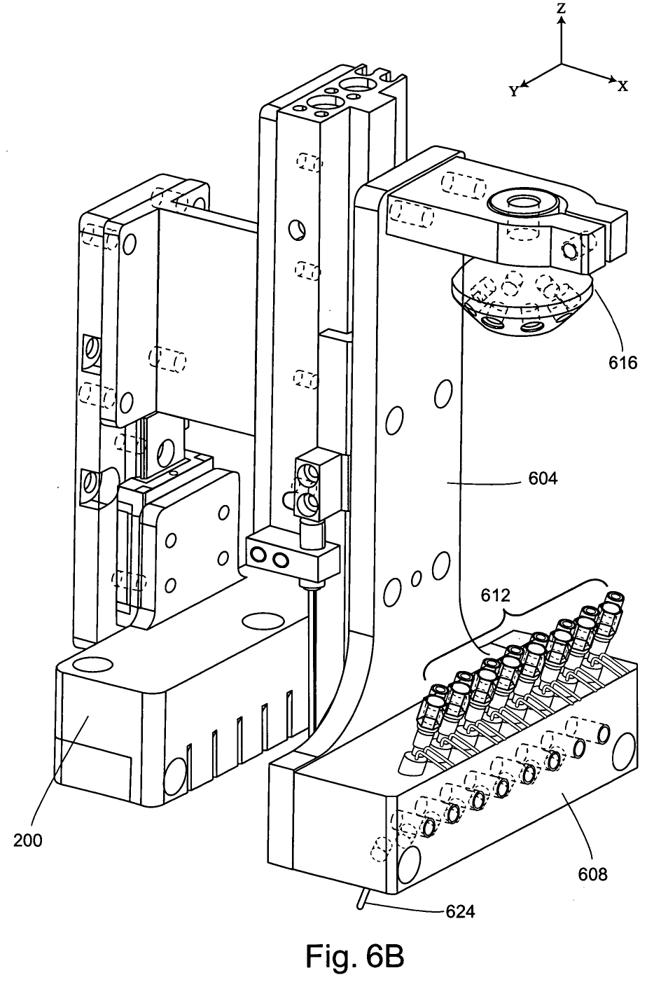

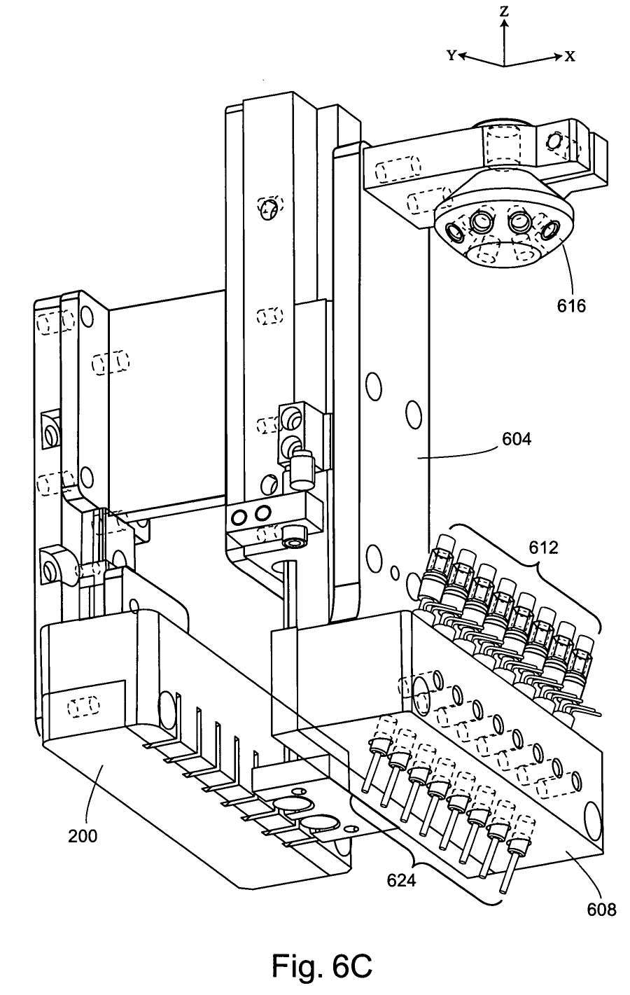

To further illustrate the systems of the invention, FIG. 6A schematically illustrates one embodiment of a multi-well plate processing system from a perspective view. As shown, multi-well plate processing system 600 includes material removal head 200 mounted on Y- and Z-axis translocation component 602. Translocation component 602 is structured to translocate material removal head 200 and/or other components such as dispensing components (described further below) along the Z-axis, e.g., to contact a multi-well plate for material removal. Translocation component 602 is also structured to translocate these components along the Y-axis, e.g., to move material removal head 200 and dispensing components across a multi-well plate. More specifically, drive mechanisms 638 effect Z-axis translation, whereas drive mechanism 640 effects Y-axis movement of these components. Drive mechanism 638 and 640 are typically servo motors, stepper motors, or the like. Although not shown in FIG. 6A, a tube or other conduit operably connects material removal head 200 to a negative pressure source. At least one valve (e.g., a solenoid valve, etc.) that is structured to regulate pressure flow from the negative pressure source is generally operably connected to material removal head 200 and/or the tube. In addition, one or more traps (e.g., fluid traps, containers, filters, etc.) are typically disposed in the fluid line between material removal head 200 and the negative pressure source to trap and store materials (e.g., waste materials or the like) removed from multi-well plates for subsequent disposal.

As also shown, multi-well plate processing system 600 further includes dispensing components 604 and 606 mounted on translocation component 602. Translocation component 602 also translates or moves dispensing components 604 and 606 along the Y and Z axes. Dispensing components 604 and 606 include dispense heads 608 and 610. Although not shown, tubes or other fluid conduits typically fluidly connect solenoid valves 612 and 614 to manifolds 616 and 618, respectively. The dispensing components of the invention optionally include peristaltic pumps, syringe pumps, bottle valves, etc. Manifolds 616 and 618 are also typically in fluid communication with one or more containers (e.g., fluid containers 620 and 622) via tubes or other fluid conduits (not shown). Fluid is generally conveyed from these containers to dispense heads 608 and 610 by operably connected fluid direction components, such as pumps or the like.

FIGS. 6B and C schematically depict a detailed top and bottom perspective view, respectively, of material removal head 200 and dispense head 608 from multi-well plate processing system 600 of FIG. 6A. Optionally, dispense heads are included in dispensing systems that do not include material removal heads. In these embodiments, the dispensing systems also typically include positioning components as described herein. In the embodiment shown in FIGS. 6B and C, dispensers or dispense tips 624 (shown as nozzles) are disposed in dispense head 608 at angles relative to the vertical or Z-axis. To illustrate, the angles are typically between about 0° and about 90° relative to the Z-axis, more typically between about 15° and about 75° relative to the Z-axis, and still more typically between about 30° and about 60° (e.g., about 35°, 40°, 45°, 50°, 55°, etc.) relative to the Z-axis. As shown, dispense tips 624 of dispense head 608 are disposed at about 45° angles relative to the Z-axis. During operation, once fluid has been removed from a multi-well plate, dispense head 608 is optionally utilized to fill selected wells in the plate, e.g., with a cleaning fluid, reagent, or the like. Dispense tips 624 are angled so that fluid is dispensed onto the sides of the selected wells, e.g., to ensure that non-removed material (e.g., cells, etc.) disposed on the bottom of the selected wells is not disturbed when fluids are dispensed. This spreads the flow of fluid and dissipates some of the kinetic energy of the flow stream to minimize the formation of bubbles or foam in the wells.

Bubbles should generally be avoided, for example, because they create inaccurate readings with most imagers used for detection in multi-well plates. To illustrate, one type of imager detects absorbance. In some of these embodiments, light is shined through the fluid from the bottom of a plate and a camera is located above the plate to capture the image. The signal is generally determined by the amount of light that passes through the fluid, e.g., to further determine fluid concentration in the wells. With bubbles or foam in a well, the light path is disrupted and a lower signal results, giving, e.g., a lower concentration reading than if the well lacked the bubbles. To further illustrate, another type of imager detects fluorescent intensity. In certain embodiments, this type of imager shines light into a well from above the multi-well plate while a camera, also above the well, detects the intensity of light that fluoresces back. This type of imager is sensitive to fluid height. The higher the fluid-level in a given well, the higher the signal will generally be from that well. With bubbles in a well, the height of the fluid in the well is higher than it would be without the bubbles. This will typically produce a higher signal than without the bubbles, thereby yielding an inaccurately high volume reading for the well.

In lieu of the angled dispensers of the present invention, bubbles are optionally removed by spinning the multi-well plates in a centrifuge or letting the plates sit until the bubbles diffuse out of the solution. However, these approaches to removing bubbles, once formed, significantly limit throughput relative to processes that utilize the angled dispense heads and systems of the invention, which minimize the formation of bubbles altogether and accordingly, do not require the use of other devices, such as centrifuges to dissipate bubbles.

Optionally, dispense tips are disposed substantially parallel, e.g., with the Z-axis. This is illustrated, for example, in dispense head 610. In some embodiments, the dispensing component is structured to dispense the materials to a plurality of multi-well plates substantially simultaneously. Dispensing components for dispensing fluids to multiple multi-well plates, which are optionally adapted for use in the systems of the present invention are described further in, e.g., International Publication No. WO 02/076830, entitled “MASSIVELY PARALLEL FLUID DISPENSING SYSTEMS AND METHODS,” filed Mar. 27, 2002 by Downs et al., which is incorporated by reference in its entirety.

As also shown in FIG. 6A, multi-well plate processing system 600 includes positioning component 626, which precisely positions multi-well plates relative to material removal head 200 and dispense heads 608 and 610 so that materials can be removed from and/or dispensed into selected wells of a multi-well plate. Positioning component 626 is mounted on X-axis translocation component 628, which moves (e.g., slides) positioning component 626 along the X-axis to align wells disposed in multi-well plates with inlets to material removal head 200 and dispense tips of dispense heads 608 and 610. A drive mechanism (not shown), such as a servo motor, a stepper motor, or the like, is generally operably connected to X-axis translocation component 628 to effect movement of positioning component 626 and/or other components. Typically, the positioning components of the invention includes appropriate mounting/alignment structural elements, such as alignment pins and/or holes, nesting wells, or the like, e.g., to facilitate proper alignment of multi-well plates with system components. Additional details relating to positioning components that can be utilized in the systems of the invention are described in, e.g., International Publication No. WO 01/96880, entitled “AUTOMATED PRECISION OBJECT HOLDER,” filed Jun. 15, 2001 by Mainquist et al., which is incorporated by reference in its entirety.

Multi-well plate processing system 600 also includes washing component 630, which is structured to wash or otherwise clean material removal head 200 and dispense tips of dispense heads 608 and 610. Washing component 630 is also mounted on X-axis translocation component 628 (e.g., a multi-well plate moving component, etc.). In addition to moving positioning component 626, translocation component 628 also moves (e.g., slides) washing component 630 along the X-axis to align material removal head 200 and dispense tips of dispense heads 608 and 610 with components of washing component 630. More particularly, washing component 630 includes recirculation bath or trough 632 into which translocation component 602 lowers material removal head 200 for cleaning, e.g., after materials have been removed from a multi-well plate positioned on positioning component 626. In addition, washing component 630 also includes vacuum ports 634 and 636 into which dispense tips of dispense heads 608 and 610 are lowered, respectively, by translocation component 602 to remove, e.g., fluid or other materials adhered to external surfaces of the dispense tips.

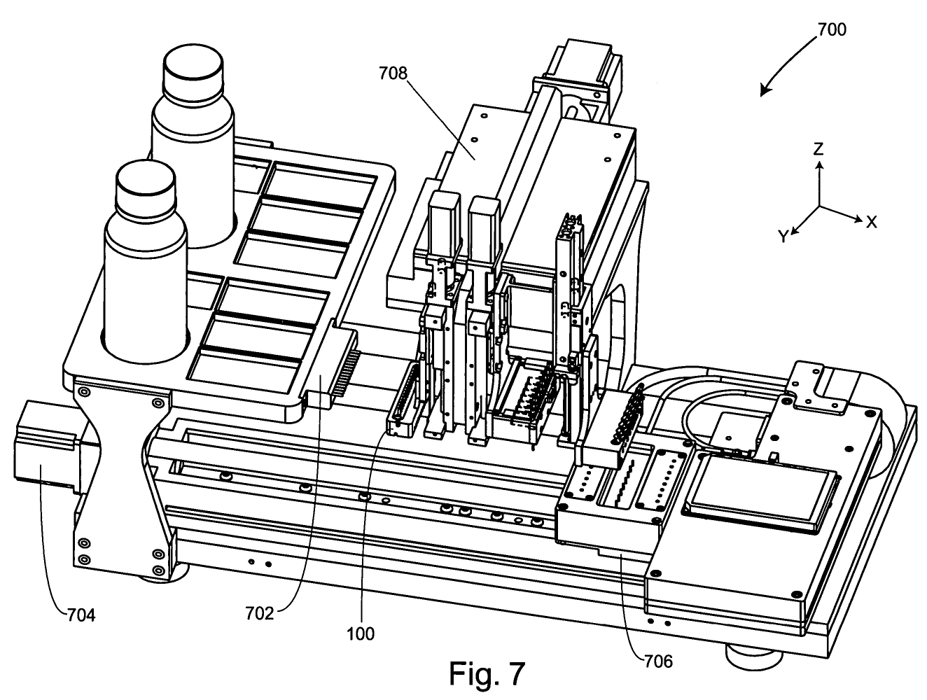

FIG. 7 schematically illustrates another preferred embodiment of a multi-well plate processing system of the present invention. As shown, multi-well plate processing system 700 includes material removal head 100 mounted on Y- and Z-axis translocation component 708. Although not shown in FIG. 7, tubes or other conduits operably connect material removal head 100 to a negative pressure source via manifold 702. In some embodiments, for example, a single tube connects the negative pressure source to manifold 702, while multiple tubes connect manifold 702 to the outlets of material removal head 100. Manifolds are optionally separate components from material removal heads, such as manifold 702, or fabricated integral with material removal heads. The tubes or other conduits have cross-sectional dimensions that are large enough not to restrict vacuum flow from the negative pressure source. At least one valve (e.g., a solenoid valve, etc.) that is structured to regulate pressure flow from the negative pressure source is generally operably connected to material removal head 100, manifold 702, and/or the tubes. Other aspects of multi-well plate processing system 700 are the same or similar to those described above with respect to multi-well plate processing system 600 with certain exceptions. For example, dispense heads 608 and 610 are both included as components of dispensing component 604, with material removal head 100 being included as a component of dispensing component 606. In the system schematically illustrated in FIG. 6A, material removal head 200 is included as a component of dispensing component 604. In addition, manifolds 616 and 618, which are illustrated in FIG. 6A, are also optionally adapted for use with multi-well plate processing system 700. Furthermore, drive mechanism 704 (e.g., a servo motor, stepper motor, etc.), which is operably connected to X-axis translocation component 706 to effect movement of X-axis translocation component 706 is also typically included in multi-well plate processing system 600 to similarly effect movement of X-axis translocation component 628.

The systems of the invention optionally further include various incubation components and/or multi-well plate storage components. In some embodiments, for example, systems include incubation components that are structured to incubate or regulate temperatures within multi-well plates. To illustrate, many cell-based or other types of assays include incubation steps and can be performed using these systems. Additional details regarding incubation devices that are optionally adapted for use with the systems of the present invention are described in, e.g., International Application No. PCT/US02/23042, entitled “HIGH THROUGHPUT INCUBATION DEVICES,” filed Jul. 18, 2002 by Weselak et al., which is incorporated by reference in its entirety. In certain embodiments, multi-well plate processing systems of the invention include multi-well plate storage components that are structured to store one or more multi-well plates. Such storage components typically include multi-well plate hotels or carousels that are known in the art and readily available from various commercial suppliers, such as Beckman Coulter, Inc. (Fullerton, Calif.). For example, in one embodiment, a multi-well plate processing system of the invention includes a stand-alone station in which a user loads a number of multi-well plates to be washed or otherwise processed into one or more storage components of the system for automated processing of the plates. In these embodiments, the systems of the invention also typically include one or more robotic gripper apparatus that move plates, e.g., between incubation or storage components and positioning components. Robotic grippers that are suitable for use in the systems of the invention are described further below or otherwise known in the art. For example, a TECAN® robot, which is commercially available from Clontech (Palo Alto, Calif.), is optionally adapted for use in the systems described herein.

In certain embodiments, the systems of the invention also include at least one detection component that is structured to detect detectable signals produced, e.g., in wells of multi-well plates. Suitable signal detectors that are optionally utilized in these systems detect, e.g., fluorescence, phosphorescence, radioactivity, mass, concentration, pH, charge, absorbance, refractive index, luminescence, temperature, magnetism, or the like. Detectors optionally monitor one or a plurality of signals from upstream and/or downstream of the performance of, e.g., a given assay step. For example, the detector optionally monitors a plurality of optical signals, which correspond in position to “real time” results. Example detectors or sensors include photomultiplier tubes, CCD arrays, optical sensors, temperature sensors, pressure sensors, pH sensors, conductivity sensors, scanning detectors, or the like. Each of these as well as other types of sensors is optionally readily incorporated into the systems described herein. The detector optionally moves relative to multi-well plates or other assay components, or alternatively, multi-well plates or other assay components move relative to the detector. In certain embodiments, for example, detection components are coupled to translation components that move the detection components relative to multi-well plates positioned on positioning components of the systems described herein. Optionally, the systems of the present invention include multiple detectors. In these systems, such detectors are typically placed either in or adjacent to, e.g., a multi-well plate or other vessel, such that the detector is within sensory communication with the multi-well plate or other vessel (i.e., the detector is capable of detecting the property of the plate or vessel or portion thereof, the contents of a portion of the plate or vessel, or the like, for which that detector is intended).

The detector optionally includes or is operably linked to a computer, e.g., which has system software for converting detector signal information into assay result information or the like. For example, detectors optionally exist as separate units, or are integrated with controllers into a single instrument. Integration of these functions into a single unit facilitates connection of these instruments with the computer, by permitting the use of few or a single communication port(s) for transmitting information between system components. Computers and controllers are described further below. Detection components that are optionally included in the systems of the invention are described further in, e.g., Skoog et al., Principles of Instrumental Analysis, 5^{th} Ed., Harcourt Brace College Publishers (1998) and Currell, Analytical Instrumentation: Performance Characteristics and Quality, John Wiley & Sons, Inc. (2000), which are incorporated by reference in their entirety for all purposes.

The systems of the invention optionally also include at least one robotic gripping component that is structured to grip and translocate multi-well plates between components of the multi-well plate processing systems and/or between the multi-well plate processing systems and other locations (e.g., other work stations, etc.). In certain embodiments, for example, systems further include gripping components that move multi-well plates between positioning components, incubation components, and/or detection components. A variety of available robotic elements (robotic arms, movable platforms, etc.) can be used or modified for use with these systems, which robotic elements are typically operably connected to controllers that control their movement and other functions. Exemplary robotic gripping devices that are optionally adapted for use in the systems of the invention are described further in, e.g., International Publication No. WO 02/068157, entitled “GRIPPING MECHANISMS, APPARATUS, AND METHODS,” by Downs et al., which is incorporated by reference in its entirety for all purposes.

The multi-well plate processing systems of the invention also typically include controllers that are operably connected to one or more components (e.g., solenoid valves, pumps, translocation components, positioning components, etc.) of the system to control operation of the components. More specifically, controllers are generally included either as separate or integral system components that are utilized, e.g., to regulate the pressure applied by negative pressure sources at material removal head inlets, the quantities of samples, reagents, cleaning fluids, or the like dispensed from dispense heads, the movement of translocation components, e.g., when positioning multi-well plates relative to material removal or dispense heads, etc. Controllers and/or other system components is/are optionally coupled to an appropriately programmed processor, computer, digital device, or other information appliance (e.g., including an analog to digital or digital to analog converter as needed), which functions to instruct the operation of these instruments in accordance with preprogrammed or user input instructions, receive data and information from these instruments, and interpret, manipulate and report this information to the user.

Any controller or computer optionally includes a monitor which is often a cathode ray tube (“CRT”) display, a flat panel display (e.g., active matrix liquid crystal display, liquid crystal display, etc.), or others. Computer circuitry is often placed in a box, which includes numerous integrated circuit chips, such as a microprocessor, memory, interface circuits, and others. The box also optionally includes a hard disk drive, a floppy disk drive, a high capacity removable drive such as a writeable CD-ROM, and other common peripheral elements. Inputting devices such as a keyboard or mouse optionally provide for input from a user.

The computer typically includes appropriate software for receiving user instructions, either in the form of user input into a set of parameter fields, e.g., in a GUI, or in the form of preprogrammed instructions, e.g., preprogrammed for a variety of different specific operations. The software then converts these instructions to appropriate language for instructing the operation of one or more controllers to carry out the desired operation, e.g., varying or selecting the rate or mode of movement of various system components, directing translation of robotic gripping apparatus, material removal heads, fluid dispensing heads, or of one or more multi-well plates or other vessels, or the like. The computer then receives the data from, e.g., sensors/detectors included within the system, and interprets the data, either provides it in a user understood format, or uses that data to initiate further controller instructions, in accordance with the programming, e.g., such as in monitoring incubation temperatures, detectable signal intensity, or the like.

The computer can be, e.g., a PC (Intel x86 or Pentium chip-compatible DOS™, OS2™, WINDOWS™, WINDOWS NT™, WINDOWS95™, WINDOWS98™, WINDOWS2000™, WINDOWS XP™, LINUX-based machine, a MACINTOSH™, Power PC, or a UNIX-based (e.g., SUN™ work station) machine) or other common commercially available computer which is known to one of skill. Standard desktop applications such as word processing software (e.g., Microsoft Word™ or Corel WordPerfect™) and database software (e.g., spreadsheet software such as Microsoft Excel™, Corel Quattro PrO™, or database programs such as Microsoft Access™ or Paradox™) can be adapted to the present invention. Software for performing, e.g., material removal from selected wells of a multi-well plate is optionally constructed by one of skill using a standard programming language such as Visual basic, Fortran, Basic, Java, or the like.

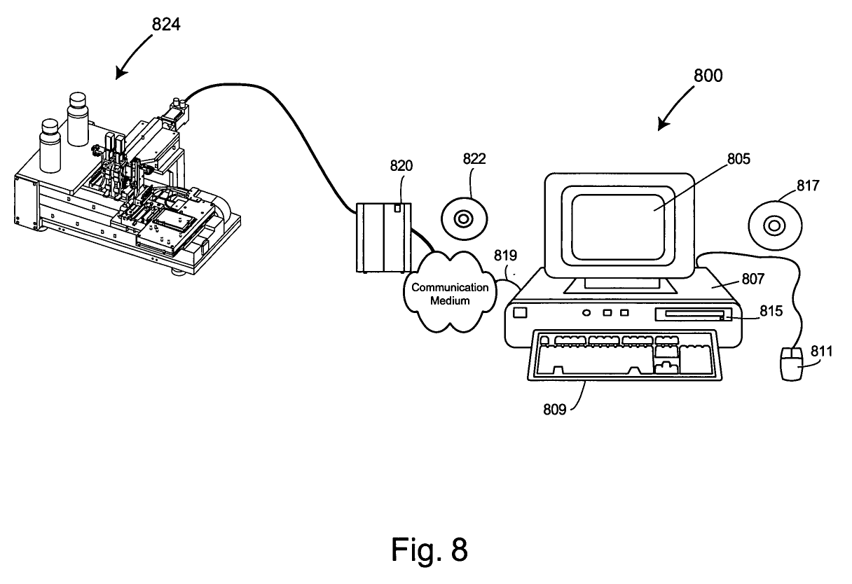

FIG. 8 is a schematic showing a representative example material removal system including an information appliance in which various aspects of the present invention may be embodied. As will be understood by practitioners in the art from the teachings provided herein, the invention is optionally implemented in hardware and software. In some embodiments, different aspects of the invention are implemented in either client-side logic or server-side logic. As will also be understood in the art, the invention or components thereof may be embodied in a media program component (e.g., a fixed media component) containing logic instructions and/or data that, when loaded into an appropriately configured computing device, cause that apparatus or system to perform according to the invention. As will additionally be understood in the art, a fixed media containing logic instructions may be delivered to a viewer on a fixed media for physically loading into a viewer's computer or a fixed media containing logic instructions may reside on a remote server that a viewer accesses through a communication medium in order to download a program component.

FIG. 8 shows information appliance or digital device 800 that may be understood as a logical apparatus (e.g., a computer, etc.) that can read instructions from media 817 and/or network port 819, which can optionally be connected to server 820 having fixed media 822. Information appliance 800 can thereafter use those instructions to direct server or client logic, as understood in the art, to embody aspects of the invention. One type of logical apparatus that may embody the invention is a computer system as illustrated in 800, containing CPU 807, optional input devices 809 and 811, disk drives 815 and optional monitor 805. Fixed media 817, or fixed media 822 over port 819, may be used to program such a system and may represent a disk-type optical or magnetic media, magnetic tape, solid state dynamic or static memory, or the like. In specific embodiments, the aspects of the invention may be embodied in whole or in part as software recorded on this fixed media. Communication port 819 may also be used to initially receive instructions that are used to program such a system and may represent any type of communication connection. Optionally, aspects of the invention is embodied in whole or in part within the circuitry of an application specific integrated circuit (ACIS) or a programmable logic device (PLD). In such a case, aspects of the invention may be embodied in a computer understandable descriptor language, which may be used to create an ASIC, or PLD. FIG. 8 also includes multi-well plate processing system 824, which is operably connected to information appliance 800 via server 820. Optionally, multi-well plate processing system 824 is directly connected to information appliance 800. During operation, multi-well plate processing system 824 typically removes fluidic materials from selected wells of multi-well plates positioned on a positioning component of multi-well plate processing system 824, e.g., as part of a process to clean the plate.

IV. Methods of Removing Material from and Dispensing Material into the Wells of Multi-Well Plates

The present invention also provides methods of removing material from multi-well plates. The methods include providing at least one material removal device or system as described herein (e.g., a hand-held device, a stand-alone work station, an automated screening system, etc.) and disposing material removal head inlets proximal to selected wells disposed in one or more multi-well plates. The methods also include applying negative pressure (e.g., a pressure of at least 28.5 inches Hg at the inlets at a flow rate of at least 0.3 cubic feet per minute at each inlet) from a negative pressure source of the device or system such that material (e.g., fluidic and/or solid material) is noninvasively removed from the selected wells substantially without cross-contaminating other wells disposed in the multi-well plates. In certain embodiments, the methods include noninvasively removing materials from a plurality of multi-well plates substantially simultaneously. Optionally, at least one other material (e.g., cellular material or another non-fluidic material) is selectively not removed from the well. This selectivity is particularly advantageous when performing cell-based assays (e.g., cell-based ELISA assays, etc.) using the multi-well plate format, as it is typically desirable to retain cells in the wells, e.g., during various wash steps. The methods of the present invention significantly increase the throughput achievable for these and other screening assays relative to those performed using pre-existing methods.

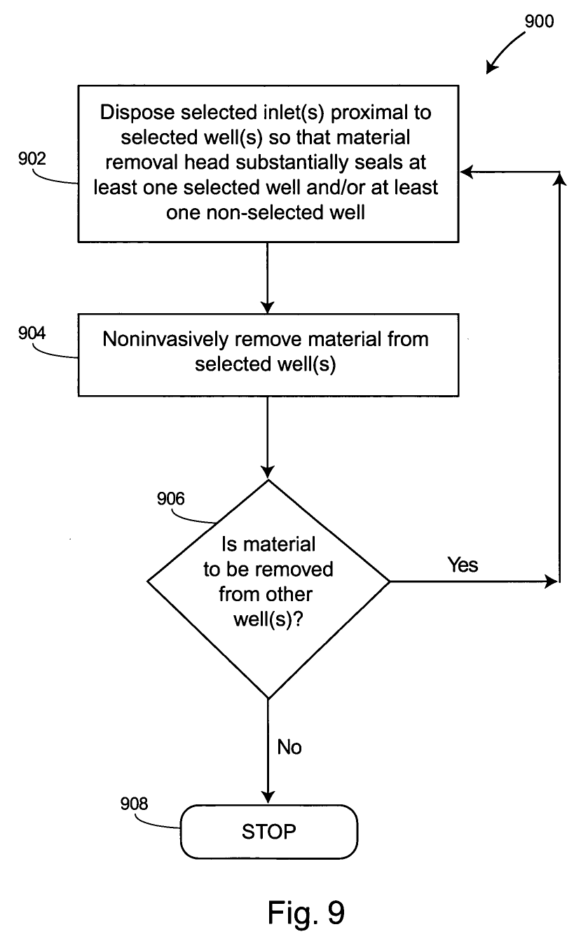

To further illustrate, FIG. 9 is a flowchart showing method 900 of removing material from a multi-well plate according to one embodiment of the invention. As shown, step 902 includes disposing selected inlets proximal to selected wells so that the material removal head substantially seals at least one selected well and/or at least one non-selected well. In a particular step of the method, a selected well is one from which material is to be removed, whereas materials are not to be removed from non-selected wells at least during that step. As shown in step 904, the method includes non-invasively removing material from the selected wells of the multi-well plate. If material is to be removed from other wells, then as shown in step 906, the method includes disposing selected inlets proximal to those wells (i.e., the method continues by feeding back to step 902). If no material is to be removed from other wells, then as shown in step 906, the method stops (step 908). Although not shown, additional steps, such as dispensing steps, multi-well plate translocation steps, and/or material removal head washing steps are optionally performed before or after selected steps in this method. In some embodiments, the method further includes detecting detectable signals produced in one or more wells using a detector.

In one preferred embodiment of the invention, the material removal head is designed to move across a multi-well plate cleaning out, e.g., 16 wells at a time. An exemplary material removal head of this type is schematically depicted in FIG. 1 and is further described in the related description provided above. This process typically begins by aligning the tips of the material removal head over the first group of wells to be aspirated. The wash head is lowered so that the tips plug into the wells to be aspirated. The end of each tip is designed to mate with the top edge of a single well, leaving a vent opening through which air is drawn through the inlet. As referred to above, the tips can be designed to mate with any well shape. When in position, the tips of this particular head extend only about 0.2 mm into the wells and fluid volumes in the wells are maintained below this level. Accordingly, the tips do not extend down into the fluid (i.e., the aspiration or fluid removal will be non-contact or noninvasive). When vacuum is applied to the tip inlets, fluid is removed from a well.

When the wash head is lowered onto the first column of wells to be cleaned, the mate between the tip and the top edges of the wells forms a barrier between the wells to be cleaned and all material-containing wells surrounding those to be cleaned. In addition, each tip in this embodiment is individually spring loaded (i.e., resiliently coupled) to account for well-to-well and plate-to-plate variations. A solenoid valve is then typically opened to activate the vacuum line. Air is sucked into the wash head through the vent opening. As the fast moving air is pulled into the wash head, it creates a venturi effect that pulls up fluid from the well. This venturi effect is generally strong enough to remove the fluid, but gentle enough as to not disturb, e.g., the cells at the bottom of the well. Since the tip forms a barrier between the well being cleaned and all surrounding fluid-containing wells there is no cross-well contamination.

When fluid has been removed from the wells, the solenoid valve turns off the vacuum flow from the negative pressure source. The material removal or washer head is then moved to the next column on the 1536 well plate. Once in place, the process described above is repeated. This time the wells that have previously been cleaned are not sealed, but because they are substantially devoid of fluid, no cross-well contamination occurs. The washer moves across the plate following this process. The washer can also be run with the vacuum on constantly. This allows for a much faster cycle times. Cross-contamination is minimized using this method and does not affect the assay.

Once fluid has been removed from the plate, a dispense head typically fills each well with a cleaning fluid. The tips on this dispenser are typically angled (as described herein) so that fluid is dispensed onto the side of each selected well. This ensures that any material (e.g., cells, etc.) on the bottom of each well is not disturbed. As described above, the use of the angled dispensers of the invention also minimizes the formation of bubbles in the wells of multi-well plates during these dispense processes. The cleaning fluid will then typically be removed following the method described above. Washing is then optionally repeated or the plate can move on to the next step in an assay.

In some embodiments, fluids can be dispensed into wells through the inlets of the wash head. For example, the outlets can be connected to a valve that, in one position, is operably connected to the negative pressure source and therefore draws materials out of the wells. When the valve is switched to a second position, an operable connection is formed between the outlets of the wash head and a reservoir that contains a fluid that is to be dispensed into the wells. By cycling the valve one or more times, one can quickly perform several cycles of wash and removal.

The methods described above are optionally performed, typically with certain variations, using any of the material removal heads described herein. In certain embodiments, for example, a material removal head such as the one schematically depicted in FIG. 2 is optionally used. In these embodiments, a surface of the material removal head is typically contacted with a surface of the multi-well plate such that inlets to the head align with wells from which materials are to be removed. The surface of the material removal head in contact with the plate typically seals others wells disposed in the multi-well plate that are not disposed proximal to the inlet. Thus, when negative pressure is applied to the inlets of these material removal heads materials are removed from selected wells substantially without cross-contaminating other wells.

V. Material Removal and Dispensing Kits

The present invention also provides kits that include at least one material removal head, dispense head, and/or components thereof. For example, a kit typically includes top and bottom head components, body structures, tips, resilient couplings (e.g., springs, formed elastomeric materials, etc.), capture plates, and/or fastening components (e.g., screws, bolts, or the like) to assemble head components and/or to attach material removal and/or dispense heads to other device or system components. The material removal and/or dispense heads of the kits of the invention are optionally pre-assembled (e.g., include components that are integral with one another, etc.) or unassembled. In addition, kits typically further include appropriate instructions for assembling, utilizing, and maintaining the material removal heads, dispense heads, and/or components thereof. Kits also typically include packaging materials or containers for holding kit components.

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above may be used in various combinations. All publications, patents, patent applications, or other documents cited in this application are incorporated by reference in their entirety for all purposes to the same extent as if each individual publication, patent, patent application, or other document were individually indicated to be incorporated by reference for all purposes.

1. A material removal head for removing materials from one or more wells of a multi-well plate, the material removal head comprising at least one tip that:
a) comprises at least one vent opening, at least one inlet and at least one outlet, which inlet communicates with the outlet; and
b) is structured such that when the inlet is disposed proximal to a selected well from which a material is to be removed, the tip forms a barrier between the selected well and at least one adjacent well;
wherein when the outlet is operably connected to a negative pressure source, air is drawn through the vent opening and into the inlet, thereby noninvasively removing material from the selected well while the barrier prevents cross-contamination of the adjacent well.

2. The material removal head of claim 1, wherein the tip is structured such that when the inlet is disposed proximal to the selected well, the tip forms a barrier between the selected well and three adjacent wells.

3. The material removal head of claim 1, wherein the tip is coupled to a body structure of the material removal head by a resilient coupling.

4. The material removal head of claim 1, wherein the material removal head comprises multiple tips.

5. The material removal head of claim 1, wherein the material removal head comprises at least one manifold.

6. The material removal head of claim 1, wherein the material removal head comprises at least two tips, wherein the inlets of the tips are spaced at a distance that substantially corresponds to a distance between at least two wells disposed in a multi-well plate.

7. The material removal head of claim 1, wherein the material removal head comprises a plurality of tips in which centers of at least two of the inlets of the tips are spaced 18 mm, 9 mm, 4.5 mm, 2.25 mm, or less apart from one another.

8. The material removal head of claim 1, wherein the material removal head is structured to noninvasively remove materials from a plurality of multi-well plates substantially simultaneously.

9. The material removal head of claim 1, wherein the tip is structured to noninvasively remove fluidic material from the selected well.

10. The material removal head of claim 1, wherein the tips comprise a cross-sectional shape selected from the group consisting of: a regular n-sided polygon, an irregular n-sided polygon, a triangle, a square, a rectangle, a trapezoid, a circle, and an oval.

11. The material removal head of claim 1, wherein the tips are structured to noninvasively remove materials from multi-well plates that comprise 6, 12, 24, 48, 96, 192, 384, 768, 1536, or more wells.

12. The material removal head of claim 1, wherein a cross-sectional area of the tip is less than a cross-sectional area of at least one well disposed in a multi-well plate.

13. The material removal head of claim 1, wherein at least one section of the tip comprises an acute edge.

14. The material removal head of claim 1, wherein the material removal head further comprises at least one mounting bracket that mounts the material removal head to at least one device component.

15. The material removal head of claim 1, wherein the tip comprises angled surfaces that mate with sides of the selected well.

16. The material removal head of claim 15, wherein one of the angled surfaces comprises the vent opening that allows air passage into the selected well.

17. The material removal head of claim 16, wherein the tip comprises an acute edge that forms a boundary of the vent opening.

18. The material removal head of claim 1, wherein the tip comprises a seal material disposed around the tip.

19. The material removal head of claim 18, wherein the seal material comprises rubber or another compliant material.

20. The material removal head of claim 18, wherein the vent opening is formed between the seal material and one side of the tip, which vent opening allows air passage into the selected well.

21. The material removal head of claim 1, wherein the material removal head comprises a plurality of tips, at least a subset of which comprises a footprint that substantially corresponds to a footprint of at least a subset of at least one line of wells disposed in a multi-well plate.

22. The material removal head of claim 21, wherein the number of spacing regions disposed between adjacent tips in a line of tips is a multiple of the number of spacing regions disposed between adjacent wells in a corresponding line of wells disposed in the multi-well plate.

23. The material removal head of claim 1, further comprising the negative pressure source operably connected to the outlet, which material removal head and negative pressure source together comprise a material removal device.

24. The material removal head of claim 23, wherein the negative pressure source is integral with the material removal head.

25. The material removal head of claim 23, wherein the negative pressure source comprises a pump.

26. The material removal head of claim 23, wherein the negative pressure source applies a pressure of at least 28.5 inches Hg at the inlet at a flow rate of at least 0.3 cubic feet per minute.

27. The material removal head of claim 23, wherein at least one tube operably connects the negative pressure source to the outlet.

28. The material removal head of claim 23, wherein the material removal device is hand-held.

29. The material removal head of claim 23, further comprising at least one trap operably connected to the material removal device, which trap is structured to trap waste material.

30. The material removal head of claim 23, further comprising at least one valve operably connected to the material removal device, which valve regulates pressure flow from the negative pressure source.

31. The material removal head of claim 30, wherein the valve comprises a solenoid valve.

32. A material removal head comprising at least one vent opening, at least one inlet and at least one outlet, which inlet communicates with the outlet, wherein the inlet is structured to noninvasively remove material from at least one selected well disposed in at least one multi-well plate when the outlet is operably connected to at least one negative pressure source, and wherein a surface of the material removal head that comprises the inlet is structured to substantially seal at least one non-selected well in the multi-well plate when the inlet is disposed proximal to the selected well from which the material is to be removed.

33. The material removal head of claim 32, wherein the surface of the material removal head that comprises the inlet is substantially flat.

34. The material removal head of claim 32, wherein at least one section of the inlet comprises an acute edge that separates the inlet from the vent opening.

35. The material removal head of claim 32, further comprising the negative pressure source operably connected to the outlet, which material removal head and negative pressure source together comprise a material removal device.

36. The material removal head of claim 35, wherein the negative pressure source is integral with the material removal head.

37. The material removal head of claim 35, wherein the negative pressure source comprises a pump.

38. The material removal head of claim 35, wherein the negative pressure source applies a pressure of at least 28.5 inches Hg at the inlet at a flow rate of at least 0.3 cubic feet per minute.

39. The material removal head of claim 35, wherein at least one tube operably connects the negative pressure source to the outlet.

40. The material removal head of claim 35, wherein the material removal device is hand-held.

41. The material removal head of claim 35, further comprising at least one trap operably connected to the material removal device, which trap is structured to trap waste material.

42. The material removal head of claim 35, further comprising at least one valve operably connected to the material removal device, which valve regulates pressure flow from the negative pressure source.

43. The material removal head of claim 42, wherein the valve comprises a solenoid valve.

44. A material removal head comprising at least one tip that extends from the material removal head, which tip comprises at least one vent opening and at least one inlet, wherein the material removal head further comprises at least one outlet that communicates with the inlet, wherein the inlet is structured to noninvasively remove material from at least one well disposed in at least one multi-well plate when the outlet is operably connected to at least one negative pressure source thereby drawing air through the vent opening and into the inlet, and wherein the tip is structured to mate with the well from which the material is to be removed to form a barrier between the well and one or more adjacent material-containing wells when the material is removed.

45. A material removal head comprising at least one vent opening, at least one inlet and at least one outlet, which inlet communicates with the outlet, wherein the inlet comprises a first cross-sectional dimension that is less than a first cross-sectional dimension of at least one well disposed in at least one multi-well plate and a second cross-sectional dimension that substantially corresponds to at least a segment of a length of at least one line of wells disposed in the multi-well plate, which inlet is structured to noninvasively remove material from one or more wells disposed in the line of wells when the outlet is operably connected to at least one negative pressure source and wherein a surface of the material removal head that comprises the inlet is structured to substantially seal at least one other well in the multi-well plate when the inlet is disposed proximal to the well from which the material is to be removed.

46. A dispense head comprising at least one dispenser that is structured to dispense material into one or more wells of at least one multi-well plate, which dispenser is angled relative to a Z-axis so that the material is dispensed onto the sides of the wells when the dispenser is operably connected to a material source and the material is dispensed from the dispenser.

47. A multi-well plate processing system, comprising:
a) at least one material removal head comprising at least one tip that:
i) comprises at least one vent opening, at least one inlet and at least one outlet, which inlet communicates with the outlet; and
ii) is structured such that when the inlet is disposed proximal to a selected well from which a material is to be removed, the tip forms a barrier between the selected well and at least one adjacent well;
wherein when the outlet is operably connected to a negative pressure source, air is drawn through the vent opening and into the inlet, thereby noninvasively removing material from the selected well while the barrier prevents cross-contamination of the adjacent well;
b) at least one positioning component that is structured to position one or more multi-well plates relative to the material removal component; and/or,
c) at least one dispensing component that is structured to dispense one or more materials into one or more wells of one or more multi-well plates.

48. The multi-well plate processing system of claim 47, wherein the material removal head comprises multiple tips.

49. The multi-well plate processing system of claim 47, wherein the tip is coupled to a body structure of the material removal head by a resilient coupling.

50. The multi-well plate processing system of claim 47, wherein the tip is structured to mate with the selected well from which the material is to be removed.

51. The multi-well plate processing system of claim 47, further comprising a negative pressure source, wherein the operable connection between the outlet and the negative pressure source comprises at least one manifold.

52. The multi-well plate processing system of claim 47, wherein the material removal head comprises at least one manifold.

53. The multi-well plate processing system of claim 47, wherein the material removal head comprises at least two tips that are spaced at a distance that substantially corresponds to a distance between at least two wells disposed in a multi-well plate.

54. The multi-well plate processing system of claim 47, wherein the material removal head comprises a plurality of tips in which centers of at least two of the inlets of the tips are spaced 18 mm, 9 mm, 4.5 mm, 2.25 mm, or less apart from one another.

55. The multi-well plate processing system of claim 47, wherein the material removal head is structured to noninvasively remove materials from a plurality of multi-well plates substantially simultaneously.

56. The multi-well plate processing system of claim 47, wherein the material removal component is structured to noninvasively remove fluidic material from the multi-well plate.

57. The multi-well plate processing system of claim 47, wherein the tip comprises a cross-sectional shape selected from the group consisting of: a regular n-sided polygon, an irregular n-sided polygon, a triangle, a square, a rectangle, a trapezoid, a circle, and an oval.

58. The multi-well plate processing system of claim 47, wherein the tips are structured to noninvasively remove materials from multi-well plates that comprise 6, 12, 24, 48, 96, 192, 384, 768, 1536, or more wells.

59. The multi-well plate processing system of claim 47, wherein a cross-sectional area of the inlet is less than a cross-sectional area of a well disposed in a multi-well plate.

60. The multi-well plate processing system of claim 47, wherein at least one section of the inlet comprises an acute edge.

61. The multi-well plate processing system of claim 47, wherein at least one tube operably connects the negative pressure source to the outlet.

62. The multi-well plate processing system of claim 47, wherein the negative pressure source comprises a pump.

63. The multi-well plate processing system of claim 47, wherein the negative pressure source applies a pressure of at least 28.5 inches Hg at the inlet at a flow rate of at least 0.3 cubic feet per minute.

64. The multi-well plate processing system of claim 47, wherein the dispensing component comprises at least one dispenser that aligns with one or more wells disposed in one or more multi-well plates when the multi-well plates are disposed proximal to the dispenser.

65. The multi-well plate processing system of claim 47, wherein the dispensing component is structured to dispense one or more fluidic materials.

66. The multi-well plate processing system of claim 47, wherein the dispensing component is structured to dispense the materials to a plurality of multi-well plates substantially simultaneously.

67. The multi-well plate processing system of claim 47, wherein the dispensing component comprises at least one dispenser that is angled relative to a Z-axis.

68. The multi-well plate processing system of claim 47, further comprising at least one trap that is operably connected to the material removal component, which trap is structured to trap waste material that is removed from the wells of a multi-well plate.

69. The multi-well plate processing system of claim 47, further comprising at least one robotic gripping component that is structured to grip and translocate multi-well plates between components of the multi-well plate processing system and/or between the multi-well plate processing system and another location.

70. The multi-well plate processing system of claim 47, further comprising at least one multi-well plate storage component that is structured to store one or more multi-well plates.

71. The multi-well plate processing system of claim 47, further comprising at least one incubation component that is structured to incubate one or more multi-well plates.

72. The multi-well plate processing system of claim 47, further comprising at least one translocation component that is structured to translocate one or more of the material removal component, the positioning component, or the dispensing component relative to one another.

73. The multi-well plate processing system of claim 47, further comprising at least one washing component that is structured to wash at least a portion of the material removal component and/or the dispensing component.

74. The multi-well plate processing system of claim 47, further comprising at least one detection component that is structured to detect detectable signals produced in one or more wells disposed in one or more multi-well plates.

75. The multi-well plate processing system of claim 47, further comprising a multi-well plate moving component that is structured to move one or more multi-well plates at least relative to the material removal component.

76. The multi-well plate processing system of claim 47, wherein the material removal head comprises a plurality of tips, at least a subset of which comprises a footprint that substantially corresponds to a footprint of at least a subset of at least one line of wells disposed in a multi-well plate.

77. The multi-well plate processing system of claim 76, wherein the number of spacing regions disposed between adjacent tips in a line of tips is a multiple of the number of spacing regions disposed between adjacent wells in a corresponding line of wells disposed in the multi-well plate.

78. The multi-well plate processing system of claim 47, further comprising at least one valve operably connected to the material removal component, which valve is structured to regulate pressure flow from the negative pressure source.

79. The multi-well plate processing system of claim 78, wherein the valve comprises a solenoid valve.

80. The multi-well plate processing system of claim 47, further comprising at least one controller that is operably connected to one or more components of the multi-well plate processing system, which controller controls operation of the components.

81. The multi-well plate processing system of claim 80, wherein the controller comprises at least one computer.

82. A dispensing system, comprising:
a) at least one dispense head comprising at least one dispenser that is structured to dispense material into one or more wells of at least one multi-well plate, which dispenser is angled relative to a Z-axis so that the material is dispensed onto the sides of the wells when the dispenser is operably connected to a material source and the material is dispensed from the dispenser; and,
b) at least one positioning component that is structured to position one or more multi-well plates relative to the dispense head.

83. A method of removing material from a multi-well plate, the method comprising:
providing at least one the material removal head comprising at least one tip that:
a) comprises at least one vent opening, at least one inlet and at least one outlet, which inlet communicates with the outlet; and
b) is structured such that when the inlet is disposed proximal to a selected well from which a material is to be removed, the tip forms a barrier between the selected well and at least one adjacent well;
wherein when the outlet is operably connected to a negative pressure source, air is drawn through the vent opening and into the inlet, thereby noninvasively removing material from the selected well while the barrier prevents cross-contamination of the adjacent well;
disposing the tip proximal to at least one selected well disposed in at least one multi-well plate; and,
applying negative pressure from the negative pressure source such that material is noninvasively removed from the selected well substantially without cross-contaminating wells disposed in the multi-well plate, thereby removing material from the multi-well plate.

84. The method of claim 83, wherein the method comprises noninvasively removing materials from a plurality of multi-well plates substantially simultaneously.

85. The method of claim 83, wherein the material is fluidic material.

86. The method of claim 83, wherein the material removal head comprises at least two tips that are spaced at a distance that substantially corresponds to a distance between at least two wells disposed in the multi-well plate and the method comprises noninvasively removing materials from the wells through the inlets substantially simultaneously.

87. The method of claim 83, wherein the multi-well plate comprises 6, 12, 24, 48, 96, 192, 384, 768, 1536, or more wells.

88. The method of claim 83, wherein a cross-sectional area of the inlet is less than a cross-sectional area of the selected well.

89. The method of claim 83, wherein the negative pressure source applies a pressure of at least 28.5 inches Hg at the inlet at a flow rate of at least 0.3 cubic feet per minute.

90. The method of claim 83, further comprising detecting a detectable signal produced in one or more wells of the multi-well plate using a detector.

91. The method of claim 83, further comprising:
disposing the inlet proximal to at least one other selected well disposed in the multi-well plate, and,
applying negative pressure from the negative pressure source such that material is noninvasively removed from the other selected well.

92. The method of claim 83, wherein at least one other material is not removed from the selected well.

93. The method of claim 92, wherein the other material comprises cellular material or another non-fluidic material.

94. The method of claim 83, further comprising:
dispensing one or more materials into one or more wells using a dispenser before or after the disposing step.

95. The method of claim 94, wherein the dispenser is angled relative to a Z-axis so that the materials are dispensed onto the sides of the wells.

96. The method of claim 94, wherein the materials comprise fluidic materials.
